(19) United States
(12) Patent Application Publication
(10) Pub. No.: US 2019/0388930 A1
(43) Pub. Date: Dec. 26, 2019

(54) SPRAY DEVICE

(71) Applicant: SUMITOMO CHEMICAL COMPANY, LIMITED, Tokyo (JP)

(72) Inventors: Van Thanh DAU, Takarazuka-shi, Hyogo (JP); Takahiro OKUIE, Takarazuka-shi, Hyogo (JP)

(73) Assignee: SUMITOMO CHEMICAL COMPANY, LIMITED, Tokyo (JP)

(21) Appl. No.: 16/083,936

(22) PCT Filed: May 11, 2017
(86) PCT No.: PCT/JP2017/017910

§ 371 Date: Sep. 11, 2018

(30) Foreign Application Priority Data
May 27, 2016 (JP) 2016-106347

(51) Int. Cl. B05B 17/06; B05B 17/00; B05B 11/00

(52) U.S. Cl. CPC B05B 17/0676; B05B 11/0044; B05B 17/0646

(57) ABSTRACT

A spray device 2 according to one embodiment includes a liquid reservoir 60 that stores the liquid L to be sprayed, a liquid supply unit 58 that supplys the liquid to the liquid reservoir, and a spray unit 62 which is in communication with the liquid reservoir and is configured to spray the liquid in the liquid reservoir, wherein a liquid supply port 582a of the liquid supply unit is arranged in the liquid reservoir in a state where the liquid supply port faces a bottom portion 68 of the liquid reservoir in the liquid reservoir, and is apart from the bottom portion, and the liquid reservoir is opened to atmosphere.

### TECHNICAL FIELD

The present invention relates to a spray device.

### BACKGROUND ART

As a spray device, the technique described in Patent Literature 1 (PTL1) is known. The liquid spray device described in PTL 1 includes a tank for storing a liquid, an elastic vibration plate having many micro pores, and an ultrasonic transducer for ultra-sonically vibrating the elastic vibration plate. In this liquid spray device, the elastic vibration plate is ultrasonically vibrated by an ultrasonic transducer, so that the liquid supplied from the tank is sprayed outside the device. Other documents related to the technical field include Patent Literatures 2 and 3 (PTLs 2 and 3).

### CITATION LIST

### Patent Literature

PTL 1: Japanese Unexamined Patent Publication No. 2014-155908
PTL 2: Japanese Unexamined Patent Publication No. 2007-29772
PTL 3: Japanese Unexamined Patent Publication No. H11-56195

### SUMMARY OF INVENTION

### Technical Problem

In the technique described in PTL 1, pores are formed in a wall portion above the liquid surface of the liquid stored in the tank. These pores allow the atmospheric pressure inside and outside of the tank to be kept constant when the liquid in the tank is sprayed by driving the liquid spray device. As a result, mixing of external air into the elastic vibration plate from the micro pores due to a decrease in the pressure inside the tank is suppressed.

However, even when the pressure inside and outside the tank is kept constant, bubbles occur in the vicinity of the elastic vibration plate by ultrasonic vibration of the elastic vibration plate, and spraying may become unstable due to the bubbles.

Therefore, it is an object of the present invention to provide a spray device capable of accomplishing stable spraying.

### Solution to Problem

A spray device for spraying a liquid according to an aspect of the present invention includes: (A) a liquid reservoir storing the liquid to be sprayed; (B) a liquid supply unit supplying the liquid to the liquid reservoir; and (C) a spray unit in communication with the liquid reservoir, the spray unit including an ultrasonic transducer and a vibration plate, the vibration plate having a plurality of through holes, and spraying the liquid in the liquid reservoir by ultrasonic vibration of the ultrasonic transducer, wherein a liquid supply port of the liquid supply unit is arranged in the liquid reservoir in a state where the liquid supply port faces a bottom portion of the liquid reservoir in the liquid reservoir, and is apart from the bottom portion, and the liquid reservoir is opened to atmosphere.

In the spray device, the liquid supplied from the liquid supply unit to a liquid reservoir is stored in the liquid reservoir. Since the liquid reservoir communicates with the spray unit, the liquid in the liquid reservoir is supplied to the spray unit. When the ultrasonic transducer included in the spray unit is operated in a state where the liquid is supplied to the spray unit, the vibration plate having the plurality of through holes ultrasonically vibrates, thereby spraying the liquid from the spray unit. When the vibration plate ultrasonically vibrates, bubbles may occur in the vicinity of the spray unit due to the pressure drop of the liquid in the vicinity of the vibration plate or the outside air entering into the spray device. In the spray device, since the spray unit communicates with the liquid reservoir, bubbles occurring in the vicinity of the spray unit flow into the liquid reservoir. Since the liquid reservoir is opened to atmosphere, bubbles flowing into the liquid reservoir can be discharged to the outside of the spray device via the liquid reservoir. In this way, since bubbles occurring when the spray unit is operated are discharged to the outside of the spray device via the liquid reservoir, the bubbles are not likely to stay in the vicinity of the spray unit. Therefore, a constant amount of liquid is supplied to the spray unit via the liquid supply path without being obstructed by bubbles in the vicinity of the spray unit. As a result, stable spraying can be achieved. In addition, in the above spray device, a liquid supply port of the liquid supply unit is disposed in the liquid reservoir so as to be spaced apart from the bottom portion. Therefore, since the liquid level height of the liquid in the liquid reservoir can be kept by the distance between the liquid supply port and the bottom portion, the liquid can be stably supplied to the spray unit. As a result, stable spraying can be achieved.

A projection or a spacer may be installed upright on the bottom portion, and the liquid supply port may be in contact with an upper end of the projection or the spacer. Accordingly, the distance between the liquid supply port and the bottom portion can be surely secured.

The bottom portion may have a recess which is continuously formed toward the spray unit from vertically below the liquid supply port. Thus, the liquid supplied from the liquid supply port to the liquid reservoir can be supplied to the spray unit while the liquid is guided by the recess.

A position of an upper end of a spray area of the vibration plate may be the same as or below a position of the liquid surface in the liquid reservoir in the vertical direction. As a result, the liquid can be securely supplied to the spray area.

A spray device for spraying a liquid according to another aspect of the present invention includes: (a) a liquid reservoir storing the liquid to be sprayed; (b) a spray unit arranged vertically below the liquid reservoir, the spray unit including an ultrasonic transducer and a vibration plate, the vibration plate having a plurality of through holes, and spraying the liquid in the liquid reservoir by ultrasonic vibration of the ultrasonic transducer; (c) a liquid supply path supplying the liquid in the liquid reservoir to the spray unit; and (d) a branch path branching off from a portion of the liquid supply path on the spray unit side, and connected to the liquid reservoir, wherein the liquid reservoir is opened to atmosphere.

In the above-mentioned spray device, the liquid in the liquid reservoir is supplied to the spray unit via the liquid supply path. When the ultrasonic transducer included in the spray unit is operated in a state where the liquid is supplied to the spray unit, the vibration plate having the plurality of through holes ultrasonically vibrates, thereby spraying the liquid from the spray unit. When ultrasonic vibration of the vibration plate occurs, bubbles may occur in the vicinity of the spray unit due to the pressure drop of the liquid in the vicinity of the vibration plate or the outside air entering into the spray device. The spray device includes a branch path which branches off from a portion of the liquid supply path on the spray unit side. The branch path is connected to the liquid reservoir located above the spray unit. Therefore, bubbles occur in the vicinity of the spray unit flow into the branch path, and are guided by the branch path and flow into the liquid reservoir. Since the liquid reservoir is opened to atmosphere, bubbles flowing into the liquid reservoir from the branch path can be discharged to the outside of the spray device. In this way, since bubbles occurring when the spray unit is operated are discharged to the outside of the spray device via the branch path and the liquid reservoir, the bubbles are unlikely to stay in the vicinity of the spray unit. Therefore, without being inhibited by the bubble in the vicinity of the spray unit, a constant amount of liquid through the liquid supply path can be supplied to the spray unit. As a result, stable spraying can be accomplished.

The liquid reservoir may include: a first chamber into which the liquid is supplied from outside; and a second chamber arranged on a side of the first chamber, the second chamber being opened to atmosphere, and the liquid supply path may be connected to the first chamber, and the branch path may be connected to the second chamber.

In this case, the liquid in the first chamber is supplied to the spray unit via the liquid supply path. On the other hand, bubbles occurring in the vicinity of the spray unit flow into the second chamber via the branch path. The bubbles are discharged from the second chamber to atmosphere. Therefore, since bubbles hardly flow into the first chamber, it is possible to stably supply the liquid to the spray unit. In this embodiment, the spray device may further include a liquid supply unit supplying the liquid to the first chamber.

The first chamber and the second chamber may be adjacent to each other with a partition wall interposed therebetween, and a liquid passage connecting the first chamber and the second chamber may be formed at a lower portion of the partition wall in the vertical direction.

In this case, since the first chamber and the second chamber are connected via a liquid passage formed in the lower portion of the partition wall, the liquid in the first chamber flows into the second chamber, and is stored also in the second chamber. The liquid level height of the liquid in the second chamber is kept at the maximum height of the opening of the liquid passage on the second chamber side. This is because since the second chamber is opened to atmosphere, when the liquid level height becomes lower than the maximum height, air flows from the second chamber to the first chamber through the liquid passage so that the liquid level height in the second chamber reaches the maximum height of the opening of the liquid passage on the second chamber side, and liquid flows from the first chamber into the second chamber side. Since the liquid level height of the liquid in the second chamber is kept at the maximum height of the opening of the liquid passage on the second chamber side, the liquid pressure can be stably applied to the spray unit. As a result, spraying can be carried out stably.

The branch path may be connected to a lower portion of the second chamber in the vertical direction.

The spray unit may spray upwardly the liquid with respect to the horizontal direction. In the spray device according to another aspect of the present invention, the spray unit may spray the liquid downward in the vertical direction.

An upper portion of the liquid reservoir may include an opening through which the liquid reservoir is opened to atmosphere.

The above spray device may further include a liquid leakage prevention unit preventing liquid leakage of the liquid in the liquid reservoir. For example, the liquid leakage prevention unit may be provided so as to block the opening of the liquid reservoir.

In this case, for example, since the liquid leakage prevention unit is provided so as to block the opening of the liquid reservoir, even if the spray device falls over or tilts, liquid leakage in the liquid reservoir can be prevented.

The leakage preventing portion may include an air path for allowing atmospheric air to pass into the opening, and the air path may be bent at least once.

As a result, even if the opening is blocked by the liquid leakage prevention unit, the inside of the liquid reservoir is opened to atmosphere. In addition, since the air path is bent at least once, leakage of liquid through the air path is unlikely to occur.

The liquid leakage prevention unit may include: a housing unit having a housing space, the housing unit having a first through hole at a position facing the opening, and a second through hole opposite the first through hole in the vertical direction; and a partition plate partitioning the housing space in the vertical direction, and a region connection path may be formed in the partition plate such that the region connection path connects a region above the partition plate and a region below the partition plate at a position deviating from an imaginary straight line connecting the first through hole and the second through hole.

In this configuration, the housing space of the housing unit is partitioned by a partition plate in the vertical direction. Therefore, even if the liquid flows into the housing space from the first through hole facing the opening of the liquid reservoir, the liquid hardly reaches the second through hole opposite the first through hole. Since the partition plate has the above region connection path, the air path is constituted by the first through hole, the region connection path and the second through hole, and therefore the liquid reservoir can be opened to atmosphere.

The liquid leakage prevention unit may have a plurality of the partition plates, the plurality of partition plates may partition the housing space into a plurality of regions in the vertical direction, adjacent partition plates of the plurality of partition plates may be inclined opposite to each other with respect to the vertical direction, and the region connection path formed in each of the adjacent partition plates of the plurality of partition plates may be formed at different positions when viewed in the vertical direction.

In this configuration, the housing space of the housing unit is partitioned into a plurality of regions by a plurality of partition plates in the vertical direction. Since the air path is formed by the region connection path which is formed by a plurality of partition plates, the first through hole, and the second through hole, the liquid reservoir can be opened to atmosphere as described above. Since the partition plates are provided in the housing unit, the liquid flowing into the housing unit through the opening of the liquid reservoir and the first through hole is unlikely to leak to the outside. Further, the region connection path formed by adjacent partition plates of the plurality of partition plates is formed at different positions when viewed in the vertical direction, the air path is bent a plurality of times. Therefore, in this respect, liquid leakage hardly occurs. In addition, among the plurality of partition plates, adjacent partition plates are provided so as to be inclined opposite to each other with respect to the vertical direction. Therefore, when the spray device is returned to the correct position from the inclined or falling state, the liquid in the housing unit naturally returns to the inside of the liquid reservoir.

### Advantageous Effects of Invention

According to the spray device, the spraying of liquid from the spray device can be stabilized.

### BRIEF DESCRIPTION OF DRAWINGS

FIG. 1 is a schematic diagram of a spray device according to a first embodiment.

FIG. 2 is a cross-sectional view taken along the line II-II of the spray unit of the spray device of FIG. 1.

FIG. 3 is a perspective view of a specific configuration of an example of the spray device according to the first embodiment.

FIG. 4 is a cross-sectional view taken along line IV-IV of FIG. 3.

FIG. 5 is a top view of a chamber unit of the spray device shown in FIG. 3.

FIG. 6 is a schematic diagram of a liquid leakage prevention unit which the spray device shown in FIG. 3 can include.

FIG. 7 is a drawing showing experimental results of Experiments 1 and 2.

FIG. 8 is a drawing showing experimental results of Experiments 3 and 4.

FIG. 9 is a schematic diagram of a modified example of the spray device.

FIG. 10 is a schematic diagram of yet another modified example of the spray device.

FIG. 11 is a perspective view of a schematic configuration of an example of a spray device according to a second embodiment.

FIG. 12 is a schematic diagram of a cross-sectional configuration taken along the line XII-XII of FIG. 11.

FIG. 13 is a drawing in which liquid is omitted in FIG. 12.

FIG. 14 is an exploded perspective view of a chamber unit of the spray device shown in FIG. 11.

FIG. 15 is a drawing for describing a configuration of the spray unit of the spray device shown in FIG. 11.

FIG. 16 is a schematic diagram of a liquid leakage prevention unit of the spray device shown in FIG. 11.

FIG. 17 is a drawing showing experimental results of Experiments 5 and 6.

### DESCRIPTION OF EMBODIMENTS

Embodiments of the present invention will be described with reference to the drawings. Identical reference numerals are attached to the same elements. Duplicate description will be omitted. The dimensional ratios of the drawings do not always coincide with those described.

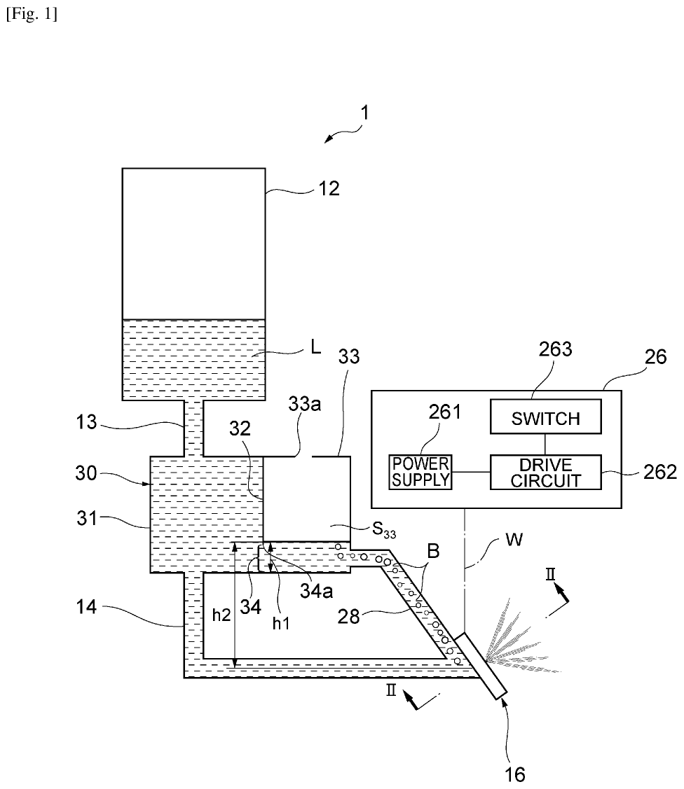

FIG. 1 is a schematic diagram of a configuration of a spray device according to the one embodiment. As shown in FIG. 1, the spray device 1 includes a liquid supply unit 12, a liquid reservoir 30, a liquid supply path 14, and a spray unit 16. The spray device 1 is a device that supplies the liquid L stored in the liquid reservoir 30 to the spray unit 16 via the liquid supply path 14 and sprays it from the spray unit 16.

The liquid supply unit 12 is a liquid supply source that supplies the liquid L to the liquid reservoir 30. The liquid supply unit 12 is, for example, a container, and an example of the container includes a tank or a bottle. An example of the liquid L includes a chemical liquid or water. The chemical liquid may be a solution which is suitable for the use of the spray device 1. Examples of chemical liquid include liquids including aromatic oils, medicines, agricultural chemicals, insecticides, and air purifying agents, cosmetic liquids, liquid foundations and the like.

The liquid reservoir 30 stores the liquid L supplied from the liquid supply unit 12. The liquid reservoir 30 has a partition wall 32, and the interior of the liquid reservoir 30 is divided into a first chamber 31 and a second chamber 33 arranged on the side of the first chamber 31 by the partition wall 32. A liquid passage 34 which connects the first chamber 31 and the second chamber 33, and through which the liquid L passes is formed in the lower portion of the partition wall 32 in the vertical direction.

The liquid supply unit 12 is connected to the upper portion of the first chamber 31 via a liquid guiding path 13. The liquid L in the liquid supply unit 12 flows into the first chamber 31. The liquid L is temporarily stored in the first chamber 31. The liquid supply path 14 is connected to a lower portion of the first chamber 31. The liquid L in the first chamber 31 is supplied to the spray unit 16 via the liquid supply path 14.

The second chamber 33 is adjacent to the first chamber 31 and is connected to the first chamber 31 through the liquid passage 34. Therefore, the liquid L flowing into the first chamber 31 is also stored in the second chamber 33. An opening 33a is formed in an upper portion of the second chamber 33. The internal space S₃₃ of the second chamber 33 is opened to atmosphere through the opening 33a. That is, the second chamber 33 is an atmosphere release chamber.

The liquid supply path 14 connects the liquid reservoir 30 and the spray unit 16. The liquid supply path 14 is a flow path for supplying the liquid L from the liquid reservoir 30 to the spray unit 16. Specifically, one end of the liquid supply path 14 is connected to the first chamber 31, and the other end is connected to the spray unit 16. As shown in FIG. 1, the liquid supply path 14 has, for example, a substantially L shape. Specifically, the liquid supply path 14 may be bent in a direction intersecting with the vertical direction after extending vertically downward from the first chamber of the liquid reservoir 30.

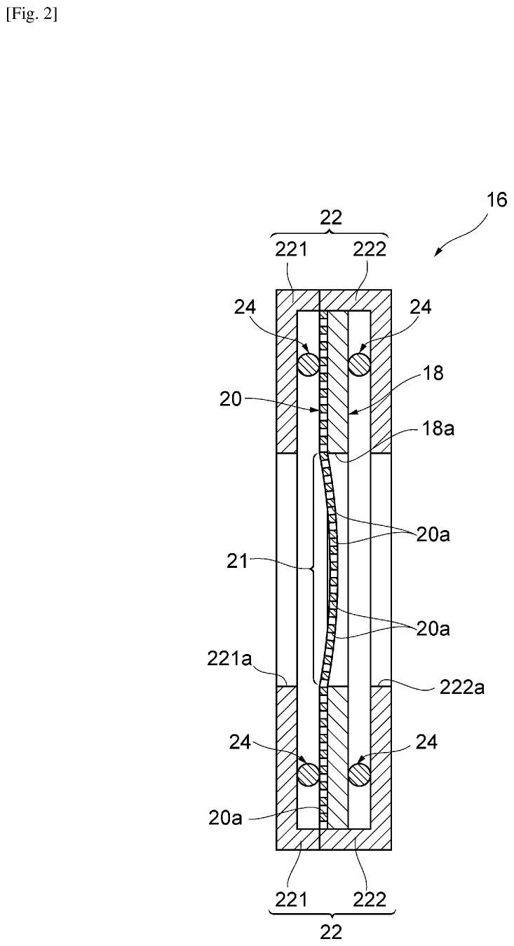

The spray unit 16 atomizes the liquid L supplied from the liquid reservoir 30 and discharges it outside the spray device 1. The spray unit 16 is attached to the liquid outlet side end portion of the liquid supply path 14 and is disposed below the liquid reservoir 30 in the vertical direction. With reference to FIG. 2, an example of the configuration of the spray unit 16 will be described. FIG. 2 shows a cross-sectional configuration of a piezoelectric spray unit as an example of the spray unit 16. As shown in FIG. 2, the spray unit 16 includes a piezoelectric transducer (ultrasonic transducer) 18 and a vibration plate 20. The spray unit 16 illustrated in FIG. 2 is connected to the liquid supply path 14 on the vibration plate 20 side relative to the piezoelectric transducer 18. That is, the liquid L flows into the spray unit 16 from the vibration plate 20 side.

The piezoelectric transducer 18 has a disk shape, and an opening 18a is formed in the center portion thereof. The piezoelectric transducer 18 may be a thin plate having a thickness of 0.1 mm to 4.0 mm. An example of the outer diameter of the piezoelectric transducer 18 is 6 mm to 60 mm. The piezoelectric transducer 18 is made of, for example, piezoelectric ceramics (for example, lead zirconate titanate (PZT)) and may be a piezoelectric element. The piezoelectric transducer 18 is configured to generate ultrasonic vibration in a radial direction. Specifically, the piezoelectric transducer 18 is polarized in the thickness direction. A high-frequency voltage is applied to electrodes (not shown) formed on both surfaces of the piezoelectric transducer 18, thereby causing ultrasonic vibration in the radial direction. An example of the resonance frequency of the piezoelectric transducer 18 is 30 kH to 500 kH.

The vibration plate 20 has a disk shape and may be a thin plate having a thickness of 0.02 mm to 2.0 mm. The outer diameter of the vibration plate 20 is selected to be larger than the inner diameter of the opening 18a of the piezoelectric transducer 18. An example of the outer diameter of the vibration plate 20 is 6 mm to 60 mm. Examples of the material of the vibration plate 20 include nickel, nickel alloy and iron alloy. In the vibration plate 20, an area facing the opening 18a of the piezoelectric transducer 18 (in other words, a facing area) is the spray area 21 for spraying the liquid L. The vibration plate 20 is joined to the piezoelectric transducer 18 so as to be coaxial with respect to the piezoelectric transducer 18 in a state of covering the opening 18a of the piezoelectric transducer 18. As illustrated in FIG. 2, the central portion or the spray area 21 of the vibration plate 20 may have a protruding shape in the spraying direction of the liquid L. The central portion or the spray area 21 of the vibration plate 20 may have a protruding shape in a direction opposite to the spray direction of the liquid L. Alternatively, the vibration plate 20 may have a flat plate shape.

In the vibration plate 20, a plurality of through holes 20a which penetrate the vibration plate 20 in the thickness direction are formed. An example of the diameter of the through hole 20a is 3 μm to 150 μm, and more preferably 3 μm to 50 μm. In the example shown in FIG. 2, the plurality of through holes 20a is formed in the entire vibration plate 20. However, it is enough that the plurality of through holes 20a are formed in the spray area 21.

The piezoelectric transducer 18 and the vibration plate 20 are housed in a casing 22 and held between a pair of elastic rings 24.

The casing 22 has a first casing member 221 having a bottomed tubular shape and a second casing member 222 having a bottomed tubular shape. The shapes and sizes of the bottom portions of the first casing member 221 and the second casing member 222 may be the same. The first casing member 221 and the second casing member 222 are combined such that the bottom portions of the first casing member 221 and the second casing member 222 face each other so as to form a housing space for housing the piezoelectric transducer 18 and the vibration plate 20. In the bottom portions of the first casing member 221 and the second casing member 222, an opening 221a and an opening 222a are formed in areas corresponding to (or facing) the opening 18a of the piezoelectric transducer 18. The opening 221a serves as an introduction port for introducing the liquid L into the casing 22, and the opening 222a serves as a spray port for the liquid L.

A method of fixing the first casing member 221 and the second casing member 222 is not particularly limited. In order to be able to replace the piezoelectric transducer 18 and the vibration plate 20, a fixing method in which the piezoelectric transducer 18 and the vibration plate 20 can be detached is preferable. For example, one of the first casing member 221 and the second casing member 222 has a claw portion, and the other of the first casing member 221 and the second casing member 222 has a portion engaged therewith (claw receiving portion), and the fixing method by their engagement and the like is exemplified. In the casing 22, a hole for allowing wiring for applying a high voltage to the piezoelectric transducer 18 to pass through is usually formed.

One elastic ring 24 of the pair of elastic rings 24 is arranged coaxially with the piezoelectric transducer 18 and the vibration plate 20 between the vibration plate 20 and the bottom portion of the first casing member 221, and the other elastic ring 24 is arranged coaxially with the piezoelectric transducer 18 and the vibration plate 20 between the piezoelectric transducer 18 and the bottom portion of the second casing member 222.

An example of the material of the elastic ring 24 is an elastic material such as rubber, and an example of the elastic ring 24 is an O-ring. The elastic ring 24 disposed between the vibration plate 20 and the bottom portion of the first casing member 221 is pressed and elastically deformed by the vibration plate 20 and the first casing member 221. The elastic ring 24 disposed between the piezoelectric transducer 18 and the bottom portion of the second casing member 222 is pressed and elastically deformed by the piezoelectric transducer 18 and the second casing member 222. As a result, the liquid L flowing into the casing 22 is confined inside the elastic ring 24, so that it does not leak from the casing 22.

An example of the configuration of the spray unit 16 is specifically described with reference to FIG. 2. The spray unit 16 may be any known piezoelectric spray unit.

As shown in FIG. 1, the spray unit 16 is electrically connected to the drive unit 26 via the wiring W. In FIG. 1, the wiring W for electrically connecting the spray unit 16 and the drive unit 26 is schematically shown by a dot-and-dash line. The drive unit 26 includes a power supply 261, a drive circuit 262, and a switch 263.

The power supply 261 is a power supply source that supplies a voltage to the spray unit 16 via the drive circuit 262. The power supply 261 is a direct current power supply, and examples thereof include dry cells. The drive circuit 262 is electrically connected to the power supply 261 and is a circuit that generates a high-frequency voltage for ultrasonically vibrating the piezoelectric transducer 18 based on the power supplied from the power supply 261. The drive circuit 262 is mounted on a circuit board, for example. The switch 263 is electrically connected to the drive circuit 262. The switch 263 switches the operation of the drive circuit 262 ON/OFF, and thereby the supply of the high-frequency voltage to the piezoelectric transducer 18 is switched ON/OFF.

In the spray device 1, the liquid L in the liquid reservoir 30 is supplied to the spray unit 16 via the liquid supply path 14. When the switch 263 of the drive unit 26 is turned on and a high-frequency voltage is supplied to the piezoelectric transducer 18 in a state where the liquid L is supplied, the piezoelectric transducer 18 ultrasonically vibrates in the radial direction. The ultrasonic vibration of the piezoelectric element causes the vibration plate 20 to ultrasonically vibrate in its thickness direction. This ultrasonic vibration of the vibration plate 20 causes the liquid L in contact with the vibration plate 20 having the plurality of through holes 20a to be atomized and sprayed from the spray unit 16 (specifically, the opening 222a) to the outside of the spray device 1. In the spray device 1, since the liquid L is directly supplied to the spray unit 16, more liquid L can be sprayed from the spray unit 16.

During the operation of the spray unit 16, the pressure of the liquid L in the vicinity of the vibration plate 20 may decrease with the vibration plate 20 ultrasonically vibrating, and bubbles B may occur in the vicinity of the spray unit 16. Alternatively, due to vibration of the vibration plate 20, gas may enter from the outside into the spray device 1, and bubbles B may occur in the vicinity of the spray unit 16.

As shown in FIG. 1, the spray device 1 further includes a bubble guide path (branch path) 28 for discharging the bubbles B in the vicinity of the spray unit 16.

The bubble guide path 28 is a branch path branching off from a portion of the liquid supply path 14 close to the spray unit 16, specifically, from the vicinity of a portion where the liquid supply path 14 is connected to the spray unit 16. The bubble guide path 28 is connected to the second chamber 33 of the liquid reservoir 30 disposed vertically above the spray unit 16. The liquid L flows into the second chamber 33 from the first chamber 31 through the liquid passage 34. Accordingly, the bubble guide path 28 that connects the second chamber 33 and the vicinity of the portion where the liquid supply path 14 disposed on the lower side of the second chamber 33 is connected to the spray unit 16 is also filled with the liquid L.

With this configuration, when bubbles B occur in the vicinity of the spray unit 16 during the operation of the spray unit 16, the bubble B naturally rises in the liquid L in the bubble guide path 28 and flows into the second chamber 33. Since the inside of the second chamber 33 is opened to atmosphere by the opening 33a, the bubbles B flowing into the second chamber 33 from the bubble guide path 28 are discharged to the outside of the spray device 1.

In the spray device 1, while the liquid supply unit 12 supplies the liquid L to the spray unit 16 mainly via the liquid supply path 14, the bubble guide path 28, which is different from the liquid supply path 14, conducts the bubbles B actively to the second chamber 33. Since the bubble guide path 28 is connected to the vicinity of the spray unit 16 of the liquid supply path 14, the bubbles B occurring in the vicinity of the spray unit 16 easily flow into the bubble guide path 28 efficiently. Therefore, the retention of the bubbles B in the vicinity of the spray unit 16 is suppressed, and it is not likely that the bubbles B will block the supply of the liquid L to the spray unit 16. As a result, stable spraying can be achieved during the operation of the spray device 1. In other words, a constant spray amount can be maintained during operation of the spray device 1.

In the spray device 1, since the bubble B can be removed by providing the bubble guide path 28, a component which can prevent the bubbles B from occurring in the vicinity of the spray unit 16 (for example, liquid absorbing medium, or the like which absorbs liquid) is not necessary. Accordingly, it is possible to supply the liquid L directly to the spray unit 16. Therefore, while the spray device 1 performs continuous spraying, the spray device 1 can spray a large amount of liquid L per unit time. Further, in the spray device 1, since the liquid L can be directly supplied to the spray unit 16, as compared with the case of supplying the liquid L to the spray unit 16 via the above-described liquid absorbing medium or the like, the liquid pressure to the spray unit 16 can be increased, and the spray distance can be lengthened.

In the spray device 1, since the bubbles B flow into the second chamber 33 via the bubble guide path 28, the bubbles B occurring in the vicinity of the spray unit 16 is suppressed from flowing into the first chamber 31 and the liquid supply unit 12 through the liquid supply path 14. If the bubbles B flow into the liquid supply unit 12, it becomes difficult to manage the air pressure inside the liquid supply unit 12, and as a result, it becomes difficult to manage the liquid pressure. On the other hand, the spray device 1 provided with the bubble guide path 28 has a configuration that facilitates liquid pressure management.

From the viewpoint of further preventing bubbles B occurring in the vicinity of the spray unit 16 from flowing into the liquid supply unit 12, preferably the bubble guide path 28 is connected to the second chamber 33, so that the bubble guide path 28 is separated from the liquid passage 34 of the second chamber 33 by a certain distance. For example, in FIG. 1, the bubble guide path 28 is connected to a position opposite to the liquid passage 34 in the second chamber 33.

In the spray device 1 having the above configuration, the liquid level height in the second chamber 33 (in other words, the amount of the liquid L) is kept at the height h1 of the upper end 34a of the second chamber side opening of the liquid passage 34. This is because when the liquid level height in the second chamber 33 becomes lower than the upper end 34a, the liquid L flows into the second chamber 33 from the first chamber 31 so that the second chamber 33 is filled with the liquid L up to the level of the upper end 34a, while air flows from the second chamber 33 through the liquid passage 34 into the first chamber 31.

The height h1 of the upper end 34a of the second chamber side opening of the liquid passage 34 is the maximum height of the second chamber side opening of the liquid passage 34 (the maximum distance from the bottom surface of the second chamber 33). Since the partition wall 32 is schematically shown in FIG. 1, the upper end 34a is shown as the lower end of the partition wall 32 of the region where the liquid passage 34 is formed. Since the upper end 34a is defined by the lower end of the partition wall 32 where the liquid passage 34 is formed, the partition wall 32 serves as a liquid level keeping wall.

As described above, since the liquid level height in the second chamber 33 is kept at the height h1 of the upper end 34a, the liquid pressure can be stably applied to the spray unit 16. In other words, it is possible to set the liquid pressure to the spray unit 16 by the height h1 of the upper end 34a. It is preferable that the height h1 is a height at which liquid leakage does not occur from the spray unit 16 in a state where the spray unit 16 is not operated.

When setting the height of the upper end 34a so as not to cause liquid leakage from the spray unit 16, it is necessary to consider the distance from the center position of the liquid outlet side opening of the liquid supply path 14 to the second chamber 33 in the vertical direction. More specifically, in order to balance the pressure in the spray device 1 so as not to cause liquid leakage from the spray unit 16, it is enough to set the distance h2 between the center position of the liquid outlet side opening of the liquid supply path 14 and the upper end 34a in the vertical direction, and the height h1 in consideration of the distance from the center position of the liquid outlet side opening of the liquid supply path 14 to the second chamber 33.

In the configuration of the spray device 1, when the liquid L is sprayed from the spray unit 16, and liquid level height in the second chamber 33 becomes lower than the height h1 of the upper end 34a of the second chamber side opening of the liquid passage 34, liquid L flows automatically from the first chamber 31 into the second chamber 33. Thus, the liquid level height of the second chamber 33 is naturally kept at the height h1. As a result, a certain amount of the liquid L in the second chamber 33 is always stored. As a result, fluctuations of the liquid pressure applied to the spray unit 16 are suppressed, and more stable spraying can be achieved.

As described above, liquid level height in the second chamber 33 is automatically kept at the height h1 of the upper end 34a. As a result, the water pressure sensor or the like is not necessary for applying a constant liquid pressure to the spray unit 16. In other words, the spray device 1 includes a configuration in which a liquid pressure management is easy. Further, since the liquid pressure can be managed by providing the liquid passage 34 in the partition wall 32, appropriate selection of materials of the partition wall 32 and the like enables liquid pressure management with low cost.

In the spray device 1, the liquid pressure applied to the spray unit 16 is determined by the height h1 of the upper end 34a. Therefore, setting the height h1 of the upper end 34a so that the liquid leakage from the spray unit 16 does not occur when the spray unit 16 is not operated makes it possible to prevent the liquid from leaking from the spray unit 16 when the spray unit 16 is not operated.

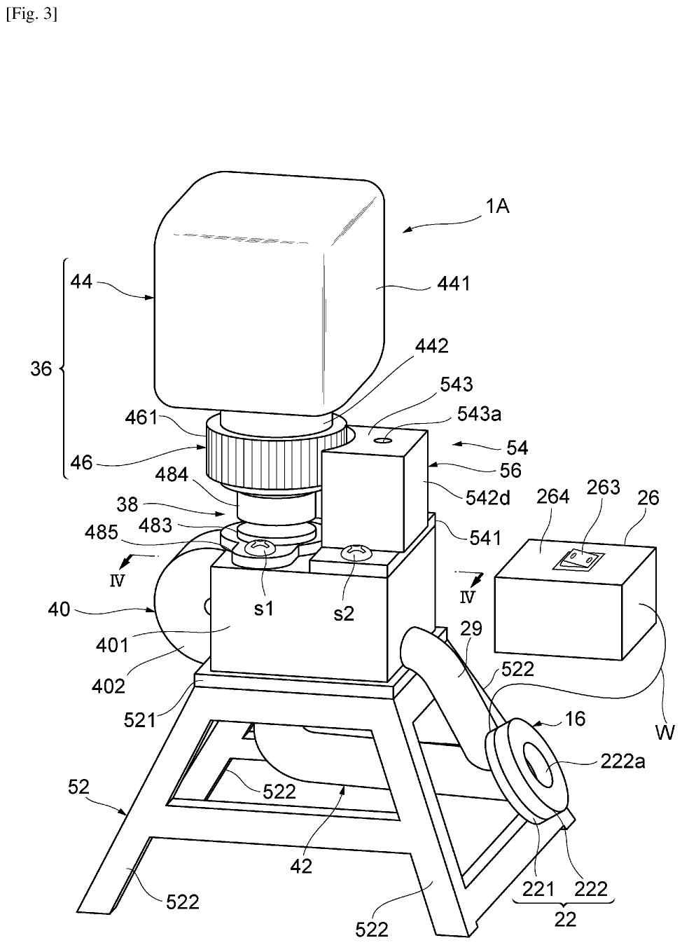

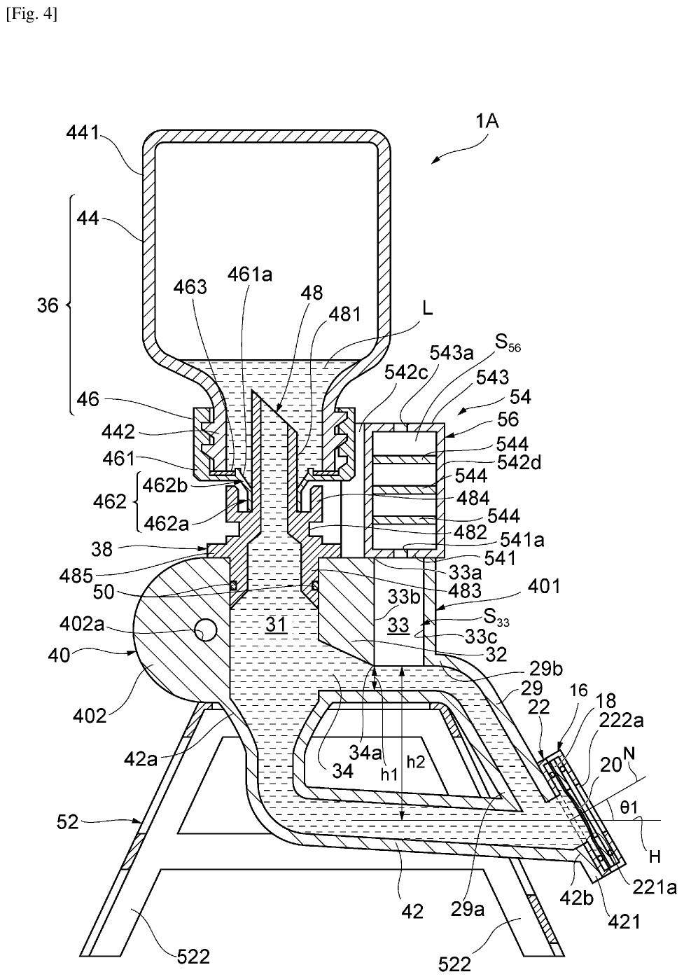

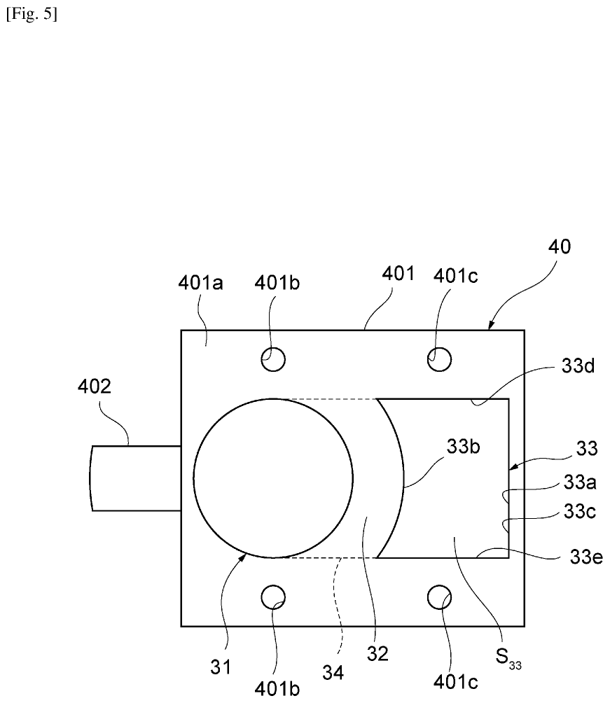

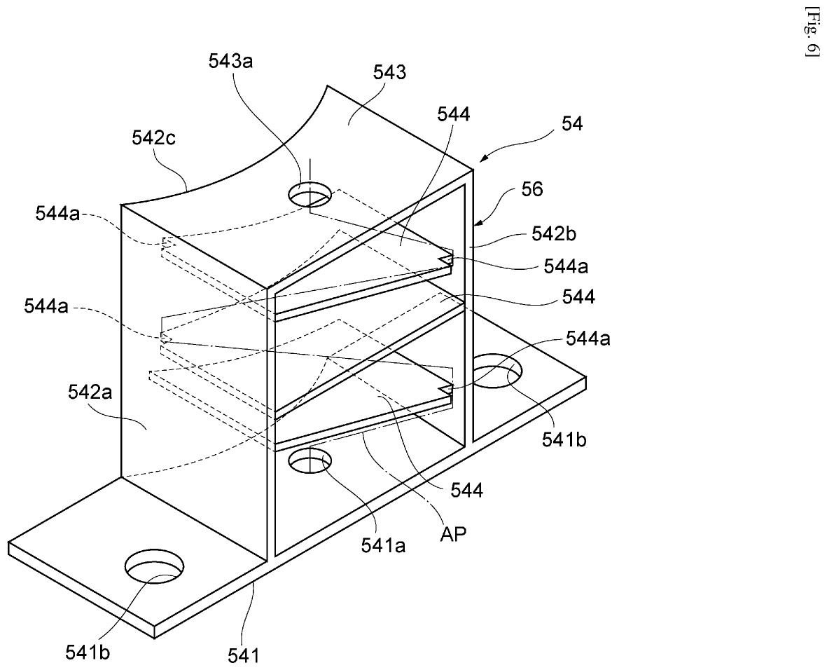

Next, a more specific configuration of the spray device 1 will be described using FIGS. 3 to 6. FIG. 3 is a perspective view of an example of the spray device. FIG. 4 is a cross-sectional view of the spray device taken along line IV-IV in FIG. 3. In FIG. 4, a drive unit of the spray unit is omitted. FIG. 5 is a top view of a chamber unit of the spray device shown in FIG. 3. FIG. 6 is a perspective view of a liquid leakage prevention unit which the spray device shown in FIG. 3 can include. The spray device 1 described using FIGS. 3 to 6 is referred to as a spray device 1A. The spray device 1A will be described with the specific examples of the components of the spray device 1. However, in the description of the spray device 1A, the description of the same components as that of the spray device 1 will be omitted or simplified.

As shown in FIGS. 3 and 4, the spray device 1A includes a tank 36, a mounting tool 38, a chamber unit 40, a liquid supply pipe 42, a spray unit 16, and a bubble guide pipe 29.

The tank 36 is a container for storing the liquid L, which serves as a liquid supply unit 12 in the spray device 1. The tank 36 includes a tank body 44 and a cap 46.

The tank body 44 includes a tubular body member 441 of which one end is closed, and a cylindrical member 442 provided at the other end of the tubular body member 441. The material of the tank body 44 is not particularly limited, and is, for example, a transparent resin such that the amount of the liquid L remaining in the tank body 44 is visible. The shape of the body member 441 is also not particularly limited, and is, for example, a square tube shape as indicated in FIG. 3. The body member 441 is narrowed toward the cylindrical member 442. A male threaded portion is formed on the outer circumference of the cylindrical member 442, which can be screwed into the cap 46.

The cap 46 is configured such that a cap body 461 is provided with a cylindrical member 462. The cap 46 is screwed into the cylindrical member 442, and thereby attached to the tank body 44. The material of the cap body 461 and the cylindrical member 462 is not particularly limited, and is, for example, the same material as that of the body member 441.

As shown in FIG. 4, the cap body 461 has a bottomed tubular shape. On the cylindrical peripheral wall of the cap body 461, a female threaded portion that receives the male threaded portion of the cylindrical member 442 is formed. The opening 461a is formed in the disc shaped bottom portion of the cap body 461. A seal member 463 for preventing liquid leakage may be provided at the bottom portion of the cap body 461 on the tank body 44 side. The seal member 463, when the cap 46 is attached to the tank body 44, is in contact with the end portion of the cylindrical member 442. With this configuration, for example, the liquid leakage from the cylindrical member 422 along the cap 46 can be prevented. The seal member 463 may, for example, has a ring shape surrounding the opening 461a.

The cylindrical member 462 is provided to be coaxial with an opening 461a on the lower surface of the bottom portion of the cap body 461. The end portion of the cylindrical member 462 on the cap body 461 side is connected to the peripheral edge of the opening 461a. The cylindrical member 462 has a cylindrical guide portion 462a having a smaller inner diameter than the inner diameter of the opening 461a. The cap body 461 and the guide portion 462a, are connected through a tapered portion 462b, which is tapered toward the guide portion 462a from the cap body 461 side.

The tank 36 is mounted in the chamber unit 40 via a mounting tool 38 in a state where the cap 46 is positioned on the lower side of the tank 36 in the vertical direction. As shown in FIG. 4, the mounting tool 38 includes a liquid guiding pipe 48.

The liquid guiding pipe 48 is a cylindrical tube that guides the liquid L in the tank 36 to the chamber unit 40, and serves as the liquid guiding path 13 shown in FIG. 1. The material of the liquid guiding pipe 48 is not particularly limited, and is, for example, a resin. The liquid guiding pipe 48 includes a first insertion member 481, an intermediate member 482, and a second insertion member 483. The first insertion member 481, the intermediate member 482 and the second insertion member 483 are integrally connected coaxially.

The first insertion member 481 is located on the tank 36 side in the liquid guiding pipe 48. The outer diameter of the first insertion member 481 is the same as the inner diameter of the guide portion 462a of the cylindrical member 462, the first insertion member 481 is inserted into the tank body 44 guided by the guide portion 462a. The end portion of the first insertion member 481 on the tank body 44 side, for example, may be sharpened as shown in FIG. 4.

The intermediate member 482 is disposed between the first insertion member 481 and the second insertion member 483, and connects them. The outer diameter of the intermediate member 482 is larger than the outer diameter of the first insertion member 481. Therefore, the outer surface of the liquid guiding pipe 48 has a step at the upper end position of the intermediate member 482, or, the connection position between the intermediate member 482 and the first insertion member 481. When the first insertion member 481 is inserted into the tank 36, the guide portion 462a is in contact with the upper end of the intermediate member 482, and thereby insertion of the first insertion member 481 into the tank 36 is restricted. The inner diameter of the intermediate member 482 may be substantially the same as the inner diameter of the first insertion member 481.

A ring-shaped peripheral wall member 484 may be installed upright from the upper end of the intermediate member 482 toward the first insertion member 481 side. The inner diameter of the peripheral wall member 484, as illustrated in FIG. 4, may be greater than the outer diameter of the guide portion 462a, or may be the same. When the first insertion member 481 is inserted into the guide portion 462a, they fit together so that liquid leakage does not occur. However, the liquid leakage may occur upon the insertion of the first insertion member 481 to the tank 36, or the like. In the embodiment in which a peripheral wall member 484 is provided, it is possible to suppress the spread of slightly leaked liquid in the above manner.

The second insertion member 483 is disposed vertically below the intermediate member 482, and has an outer diameter greater than the outer diameter of the intermediate member 482. At least a portion of the second insertion member 483 is inserted into the chamber unit 40. The inner diameter of the second insertion member 483 may be stepwise increased. As shown in FIGS. 3 and 4, the flange member 485 is provided on the outer periphery of the second insertion member 483. Flange member 485 is a mounting portion for installing a mounting tool 38 to the chamber unit 40, and has an insertion hole for allowing a screw s1 to pass through. A portion of the second insertion member 483 opposite the intermediate member 482 with respect to the flange member 485 is inserted into the chamber unit 40.

As shown in FIG. 4, a groove extending in the circumferential direction is formed on the outer periphery of a portion of the second insertion member 483 to be inserted into the chamber unit 40. An elastic ring 50 may be fitted into in the groove. The elastic ring 50 may have the same material as the elastic ring 24 shown in FIG. 2. The elastic ring 50 has a slightly larger thickness than the depth of the groove, and is elastically deformed in a state where the second insertion member 483 is inserted into the chamber unit 40. Accordingly, liquid leakage at the connecting portion between the second insertion member 483 and the chamber unit 40 can be prevented. An example of the elastic ring 50 is an O-ring.

An example of the configuration of the mounting tool 38 is described with reference to FIGS. 3 and 4. It is enough that the mounting tool 38 has a flow path corresponding to the liquid guiding path 13 shown in FIG. 1, and is configured such that the tank 36 is mountable to the chamber unit 40.

As shown in FIG. 3, the chamber unit 40 includes a chamber body 401. The chamber body 401 serves as the liquid reservoir 30 as described in the spray device 1 shown in FIG. 1. FIG. 3 illustrates an example of the chamber body 401 having a rectangular parallelepiped shape. For example, when the spray device 1A is further housed in, for example, the casing, a fixing member 402 for fixing the spray device 1A to the casing may be formed on one side surface of the chamber body 401. The fixing member 402 may have an insertion hole 402a through which a bar for fixing the spray device 1A to the wall portion of the casing for housing the spray device 1A is inserted.

As shown in FIG. 4, the material of the chamber body 401 is not particularly limited, and is, for example, a resin such as polyacetal or polyethylene.

The configuration of the chamber body 401 is specifically described with the same reference numerals for elements corresponding to the liquid reservoir 30. The chamber body 401 includes a first chamber 31 and a second chamber 33 which are adjacent to each other in the horizontal direction, and the first chamber 31 and the second chamber 33 are partitioned by a partition wall 32.

The first chamber 31 has, in its cross section, a circular internal space, and an upper wall 401a of the chamber body 401 (see FIG. 5) has, in its portion corresponding to the first chamber 31, an opening having the same diameter as the diameter of the internal space of the first chamber 31. The second insertion member 483 is inserted into the first chamber 31 through the opening. The inner diameter of the internal space of the first chamber 31 is the same as the outer diameter of the second insertion member 483. In order to secure the mounting tool 38 to the chamber unit 40 by inserting the second insertion member 483 into the first chamber 31, as shown in FIG. 5, screw holes 401b for screwing the flange member 485 are formed in the upper wall 401a of the chamber body 401.

As shown in FIGS. 4 and 5, the upper wall 401a of the chamber body 401 has, in its portion corresponding to the second chamber 33, an opening 33a through which the inside of the second chamber 33 is opened to atmosphere.

As shown in FIG. 5, the inner surface 33b of the second chamber 33 on the first chamber 31 side is curved inward with respect to the second chamber 33. The curvature of the inner surface 33b may be substantially the same as the curvature of the inner peripheral surface of the first chamber 31, which defines the first chamber 31. The inner surface 33c facing the inner surface 33b may be planar. A pair of inner surfaces 33d and 33e of the second chamber 33 which connect the inner surfaces 33b and 33c also are planar. The distance between the inner surfaces 33d and 33e may be the same as the inner diameter of the first chamber 31. Hereinafter, unless otherwise specified, the inner surfaces 33c, 33d, and 33e are planar.

The shape of the second chamber 33 is not limited. When the inner surface 33b on the first chamber 31 side is curved in accordance with the first chamber 31, the chamber body 401 can be made compact, and the desired volume of the second chamber 33 can be secured. As a result, the configuration contributes to miniaturization of the spray device 1A.

As shown in FIGS. 4 and 5, a portion of the chamber body 401 between the first chamber 31 and the second chamber 33 serves as a partition wall 32 that partitions the first chamber 31 and second chamber 33. The surface of the partition wall 32 on the second chamber 33 side is the inner side surface 33b which defines an internal space of the second chamber 33.

The liquid passage 34 which connects the first chamber 31 and the second chamber 33 is formed in the lower portion of the partition wall 32. In the liquid passage 34, the shape of the cross section perpendicular to the thickness direction of the partition wall 32 (the direction from the first chamber 31 towards the second chamber 33) is, for example, rectangular. The length of the liquid passage 34 in the normal direction with respect to the inner surface 33d (or the inner surface 33e) of the second chamber 33 may be substantially equal to the distance between the inner surface 33d and the inner surface 33e. In the embodiment shown in FIG. 4, the height of the liquid passage 34 decreases toward the second chamber 33 from the first chamber 31 side. The upper end 34a of the second chamber side opening of the liquid passage 34 corresponds to the lower end of the surface (inner surface 33b) of the partition wall 32 on the second chamber 33 side. In the following description, the height h1 of the upper end 34a is constant in the normal direction with respect to the inner surface 33d (or inner surface 33e).

The liquid supply pipe 42 is a flow path to allow the liquid L to flow into the spray unit 16 from the first chamber 31, and serves as the liquid supply path 14 shown in FIG. 1. The end portion 42a of the liquid supply pipe 42 on the liquid inlet side is coaxial with the first chamber 31 and connected to a bottom wall of the chamber body 401. The spray unit 16 is attached to the end portion 42b of the liquid supply pipe 42. The material of the liquid supply pipe 42 may be the same material as the chamber body 401.

The liquid supply pipe 42, after extending vertically downward from the first chamber 31, is bent in the direction intersecting the vertical direction. Therefore, the liquid supply pipe 42 has an L shape. In FIG. 4, the liquid supply pipe 42, which is bent after extending in the vertical direction, is bent slightly downward relative to the horizontal direction. The inner diameter of the liquid supply pipe 42 is smaller than that of the first chamber 31. Therefore, the liquid supply pipe 42 has a tapered shape tapering away from the chamber body 401 in the vicinity of the connection portion between the liquid supply pipe 42 and the chamber body 401.

The end surface of the end portion 42b of the liquid supply pipe 42 on the liquid outlet side (hereinafter also referred to as “liquid outlet side end surface”) is inclined with respect to the horizontal plane H. The liquid outlet side end surface of the liquid supply pipe 42 is inclined such that its normal N has an angle of θ1 with respect to the horizontal plane H. The angle θ1 may be 0° to 90°, and is, for example, about 30°. A flange member 421 protruding in the radial direction may be provided at an end portion 42b of the liquid supply pipe 42 to support the spray unit 16 stably.

The spray unit 16 is a spray unit described using FIG. 2. Therefore, the description of the configuration of the spray unit 16 will be omitted. The spray unit 16 is disposed such that the opening 221a of the casing 22 faces the liquid outlet of the liquid supply pipe 42. The direction of the normal N with respect to the liquid outlet side end surface of the liquid supply pipe 42 is inclined by an angle of θ1 with respect to the horizontal plane H, and thereby liquid L from the spray unit 16 is sprayed in the direction of the angle θ1 from the horizontal plane H (horizontal direction). Therefore, when the angle θ1 is greater than the 0°, for example, 30° as described above, the liquid L is sprayed in an upward direction with respect to the horizontal plane H.

As shown in FIG. 3, in the spray device 1A, the spray unit 16 (specifically the piezoelectric transducer 18) is electrically connected through wiring W to the drive unit 26 of the spray unit 16. The drive unit 26, as described using of FIG. 1, includes the power supply 261, the drive circuit 262, and the switch 263. In the example shown in FIG. 3, the power supply 261 and the drive circuit 262 is housed in the housing 264, and the switch 263 is fixed to the wall portion of the housing 264. For example, in the case in which the spray device 1A is further housed in the casing, the power supply 261, the drive circuit 262 and the switch 263 may be installed for the casing.

As shown in FIGS. 3 and 4, the bubble guide pipe 29 branches off from the liquid supply pipe 42, is connected to the second chamber 33, and serves as a bubble guide path 28 in the spray device 1 shown in FIG. 1. The material of the bubble guide pipe 29 is not particularly limited, and is, for example, a resin. The material of the bubble guide pipe 29 may be, for example, the same as the material of the liquid supply pipe 42. The end portion 29a of the bubble guide pipe 29 on the liquid supply pipe 42 side is connected to the liquid supply pipe 42 on the end portion 42b side of the liquid supply pipe 42 (in the vicinity of the spray unit 16). The end portion 29b opposite the end portion 29a of the bubble guide pipe 29 is connected to the second chamber 33. In this case, the wall portion, which has the inner surface 33c of the chamber body 401, has a through hole through which the bubble guide pipe 29 passes, or which connects the bubble guide pipe 29 and the second chamber 33.

Usually, the bubble guide pipe 29 is connected to a position at which the liquid L in the second chamber 33 flows into the bubble guide pipe 29. In the illustrated configuration in FIG. 3 and FIG. 4, the second chamber side opening of the bubble guide pipe 29 faces the second chamber side opening of the liquid passage 34. Specifically, the bubble guide pipe 29 is connected to the second chamber 33 such that the height of the upper end of the second chamber side opening of the bubble guide pipe 29 is substantially the same as the height of the upper end 34a of the liquid passage 34 in the vertical direction.

In the embodiment in which the chamber unit 40, the liquid supply pipe 42 and the bubble guide pipe 29 are composed of the same resin, they may be integrally molded. Alternatively, the liquid supply pipe 42 and the bubble guide pipe 29 are integrally molded and the chamber unit 40 is molded. Then, the liquid supply pipe 42 and the bubble guide pipe 29, which are integrated, may be fixed to the chamber unit 40.

The chamber unit 40 to which the liquid supply pipe 42 and the bubble guide pipes 29 are fixed may be supported by, for example, a base 52, as shown in FIGS. 3 and 4. The base 52 may have a frame member 521 for holding the bottom wall of the chamber unit 40, and four leg members 522 provided on the four corners of a frame member 521. Thus, even when the liquid supply pipe 42 is arranged below the chamber unit 40, the spray device 1A can be installed such that the upper wall 401a of the chamber unit 40 is parallel to the horizontal plane H.

In one embodiment, as shown in FIGS. 3 and 4, the liquid leakage prevention unit (liquid leakage prevention mechanism) 54 may be provided on the second chamber 33. An embodiment in which the liquid leakage prevention unit 54 is provided will be described. In this case, the liquid leakage prevention unit 54 is fixed to the upper wall 401a of the chamber body 401 so as to block the opening 33a of the second chamber 33. In the embodiment illustrated in FIG. 3, the liquid leakage prevention unit 54 is fixed to the chamber body 401 by a screw s2. In order to fix the liquid leakage prevention unit 54 to the chamber body 401 by the screw, as illustrated in FIG. 5, the upper wall 401a of the chamber body 401 has a screw hole 401c to receive the screw s2.

With reference to FIGS. 3, 4, and 6, an example of a configuration of the liquid leakage prevention unit 54 will be described. The liquid leakage prevention unit 54 includes a bottom plate 541, four side walls 542a, 542b, 542c, and 542d, and, a top plate 543, and a plurality of partition plates 544. In FIG. 6, in order to describe the internal structure of the liquid leakage prevention unit 54, the side wall 542d is not shown.

The bottom plate 541 has a flat plate shape, and extends in one direction. The bottom plate 541 has a through hole (first through hole) 541a penetrating the bottom plate 541 in the thickness direction. The through hole 541a is formed at a position opposite the opening 33a (in other words, a position facing the opening 33a) when the liquid leakage prevention unit 54 is attached to the chamber body 401. In the vicinity of both end portions of the bottom plate 541 in the longitudinal direction, the bottom plate 541 has through holes 541b through which screws for screwing the liquid leakage prevention unit 54 to the chamber body 401 are passed.

In the embodiment in which the inner surface 33b is curved, as shown in FIG. 5, when the liquid leakage prevention unit 54 is attached to the chamber body 401, a portion of the bottom plate 541 corresponding to the inner surface 33b of the second chamber 33 (a portion between the side wall 542a and the side wall 542b) may be curved in accordance with the curved state of the inner side surface 33b.

As shown in FIG. 6, a pair of facing side walls 542a and 542b of four side walls 542a, 542b, 542c, and 542d of the liquid leakage prevention unit 54, are installed upright on both sides of the through hole 541a in the longitudinal direction of the bottom plate 541. Another pair of the facing side walls 542c and 542d of the four side walls 542a, 542b, 542c, and 542d connects the pair of the side walls 542a and 542b. In the embodiment shown in FIG. 6, the side wall 542c is curved in accordance with the curved state of the inner surface 33b of the second chamber 33.

The top plate 543 is disposed to face the bottom plate 541, and is fixed to end portions of the four side walls 542a, 542b, 542c, and 542d, wherein the end portions are opposite to the bottom plate 541. The top plate 543 has a through hole (second through hole) 543a penetrating the top plate 543 in the thickness direction.

The four side walls 542a, 542b, 542c, and 542d, a portion of the bottom plate 541 wherein the portion is sandwiched by the pair of the side walls 542a and 542b, and the top plate 543 constitute the housing unit 56 for housing a plurality of the partition plates 544.

The plurality of the partition plates 544 are disposed in the vertical direction. Each partition plate 544 spans the pair of the side walls 542a and 542b, and has the same width as the length between the pair of the side walls 542c and 542d. The partition plates 544 and 544, which are adjacent to each other in the vertical direction, are disposed to be inclined in the opposite direction to each other with respect to the vertical direction.

A notch portion 544a in the one of the four corners of each partition plate 544 is formed. When viewed in the vertical direction, the positions of the notch portions 524a of the partition plates 544 adjacent to each other in the vertical direction are different. Each notch portion 544a is formed at the corner portion of the partition plate 544, so that a hole is formed by the inner surface of the housing unit 56 and the notch portion 544a. Each notch portion 544a serves as a region connection path connecting the regions on both sides of the partition plate 544.

The liquid leakage prevention unit 54 with the above configuration houses the three partition plates 544 in a housing space (internal space) S₅₆ of the housing unit 56. The housing space S₅₆ is partitioned by three partition plates 544 into four regions in the vertical direction. The notch portions 544a formed in the partition plates 544, the through hole 541a, and the through hole 543a form, as schematically shown by a dot-and-dash line in FIG. 6, an air path AP through which atmospheric air (air) passes into the opening 33a. Accordingly, although the liquid leakage prevention unit 54 provided on the second chamber 33 blocks the opening 33a of the second chamber 33, the opening 33a communicates with atmosphere by the air path AP. As a result, the second chamber 33 is opened to atmosphere. Since the air path AP is formed so as to connect the notch portions 544a as the region connection path formed in the partition plate 544, so that the air path AP is bent at each partition plate 544.

The spray device 1A is, for example, assembled as follows. Following is a description of an embodiment in which the spray device 1A has the liquid leakage prevention unit 54. The chamber unit 40 where the liquid supply pipe 42 and the bubble guide pipe 29 are formed integrally is prepared. At this time, the spray unit 16 is attached to the liquid supply pipe 42. The spray unit 16 may be joined to the liquid supply pipe 42 using an adhesive, for example. Thereafter, the tank 36 is fixed with screws to the first chamber 31, which is formed in the chamber body 401 of the chamber unit 40, via the mounting tool 38. Furthermore, by screwing the liquid leakage prevention unit 54 to the chamber body 401, the spray device 1A can be provided.

The above way of the assembly is an example. As long as the spray device 1A is assembled, the assembly method is not particularly limited. For example, when installing the tank 36 to the chamber body 401, the tank 36 in which the liquid L is stored may be attached to the mounting tool 38 after screwing the mounting tool 38 to the chamber body 401, or after attaching the mounting tool 38 to the tank 36, the mounting tool 38 may be screwed to the chamber body 401. Connection of the spray unit 16 and the drive unit 26 may be made either before or after attaching the spray unit 16 to the liquid supply pipe 42.

In this manner, in the spray device 1, the tank 36 is mounted in the chamber unit 40 via the mounting tool 38. Thus, the tank 36 is detachable with respect to the chamber unit 40. Therefore, when no liquid L in the tank 36 remains, it is easy to resupply the liquid L by replacing the tank 36.

While the seal member 463 provided on the cap 46 is provided around the opening 461a, for example, the seal member 463 may cover the opening 461a before attaching the mounting tool 38 to the cap 46. In this case, when mounting the first insertion member 481 of the mounting tool 38 to the cap 46, the seal member 463 may be broken by the tip of the first insertion member 481. In this case, the mounting tool 38 is attached to the chamber body 401 in advance, and then, the tank 36 is attached to the mounting tool 38, and thereby the tank 36 is mountable to the chamber body 401 while the leakage of liquid from the tank 36 is securely prevented.

In the spray device 1A, the tank 36, the chamber body 401, and the liquid supply pipe 42 respectively serve as the liquid supply unit 12, the liquid reservoir 30 and the liquid supply path 14 in the spray device 1. Accordingly, the spray device 1A, as with the spray device 1, can spray the liquid L from the spray unit 16.

Further, the bubble guide pipe 29 of the spray device 1A serves as the bubble guide path 28 in the spray device 1, and is connected to the second chamber 33, which the chamber body 401 includes, and which is opened to atmosphere. Furthermore, in the spray device 1A, the second chamber 33 and the first chamber 31 are partitioned by the partition wall 32, and the liquid passage 34 is formed by the partition wall 32. Accordingly, the spray device 1A has at least the same operations and effects as the spray device 1.

That is, the bubbles B occurring at the time of the operation of the spray unit 16 can be efficiently escaped to the second chamber 33 through the bubble guide pipe 29. As a result, stable spraying can be accomplished. Furthermore, since the liquid level height of the liquid L in the second chamber 33 can be defined at the upper end 34a of the liquid passage 34 on the second chamber 33 side, the liquid pressure applied to the spray unit 16 can be maintained at a constant value. As a result, a constant amount of spray can be maintained.

The height h1 of the upper end 34a is set in consideration of the distance h2 in the vertical direction between the center position of the liquid outlet of the liquid supply pipe 42 and the upper end 34a, and thereby liquid leakage in the non-operation of the spray unit 16 can be prevented.

As shown in FIGS. 3 and 4, in the embodiment in which the spray device 1A has the liquid leakage prevention unit 54, liquid leakage from the spray device 1A can be prevented, even when, for example, the spray device 1A falls over or tilts. Next, this will be described.

The spray device 1A is normally used in a state of being placed on a flat surface. For example, it is used in a state where the thickness direction of the chamber body 401 is substantially coincides with the vertical direction. However, the spray device 1A may tilt or further fall over. Here, on the assumption that the spray device 1A falls over, operations and effects of the liquid leakage prevention unit 54 will be described.

If the spray device 1A falls over, the liquid L stored in the second chamber 33 flows into the liquid leakage prevention unit 54 through the through hole 541a from the opening 33a. Since the housing space S₅₆ of the housing unit 56 of the liquid leakage prevention unit 54 has a constant volume, the liquid leakage prevention unit 54 (more specifically housing unit 56) can serve as a reserve tank or a buffer chamber. As a result, even if the spray device 1A falls over, liquid leakage is unlikely to occur. Since the housing space S₅₆ in the housing unit 56 is separated in the vertical direction by the partition plates 544, the partition plates 544 prevents the liquid L from flowing into the through hole 543a. In this respect, the liquid leakage is unlikely to occur.

In the liquid leakage prevention unit 54, the partition plates 544 have the notch portions 544a so that the second chamber 33 is opened to atmosphere. The notch portions 544a, together with the through hole 541a and the through hole 543a, forms the air path AP connecting the opening 33a to atmosphere. Since each notch portion 544a of the adjacent partition plates 544 is formed at different positions when viewed in the vertical direction, the air path AP is bent a plurality of times, in other words, formed in a labyrinthine shape. Therefore, for example, even if the spray device 1A falls over and the liquid L flows into the liquid leakage prevention unit 54, the liquid L is unlikely to flow to the outside from the through hole 543a through the air path AP. Thus, the liquid leakage prevention unit 54 can further prevent liquid leakage, while the second chamber 33 is opened to atmosphere through the air path AP.

The partition plates 544, which are inclined in the vertical direction, are provided in the housing unit 56, and the adjacent partition plates 544 are inclined on opposite sides to each other with respect to the vertical direction. Therefore, the liquid L which has flowed into the liquid leakage prevention unit 54 after the spray device 1A falls over, when returning the spray device 1A in the normal arrangement, is likely to fall back to the second chamber 33 by gravity along the partition plates 544.

Next, the evidence that the stable spraying can be accomplished with the spray device including a bubble guide pipe will be specifically described using the experimental results of Experiment 1 to Experiment 4.

(Experiment 1)

In Experiment 1, the spray device 1A having the embodiment illustrated in FIG. 3 was used. Therefore, Experiment 1 corresponds to an example. In Experiment 1, liquid L which was stored in the tank 36 was water. In Experiment 1, with the spray device 1A placed on a mass meter (electronic balance BP221S made by Sartorius AG), the spray device 1A was run, and the liquid L was continuously sprayed from the spray unit 16. Then, the mass represented by the mass meter at the start of the experiment, and every one minute from the start of the experiment was recorded, and the difference between a mass at the beginning of the experiment and a mass measured at each predetermined elapse time was calculated as a mass loss (g). In Experiment 1, data for 11 minutes after the start of the experiment was obtained.

(Experiment 2)

Experiment 2 was conducted in the same manner as in Experiment 1 in which the same spray device 1A as in Experiment 1 was placed on the mass meter used in Experiment 1. Therefore, Experiment 2 also corresponds to an example. In Experiment 2, the liquid L which was stored in the tank (liquid reservoir) 36 was ethanol. In Experiment 2, the mass represented by the mass meter was recorded at the start of the experiment, when two minutes have passed after the start of the experiment, and after that, every one minute, and the mass loss (g) was calculated. In Experiment 2, data for 8 minutes after the start of the experiment was obtained.

(Experiment 3)

Experiment 3 used the device corresponding to the spray device 1A shown in FIG. 3, in which the bubble guide pipe 29 was blocked. That is, in Experiment 3, the device corresponding to the spray device 1A substantially without the bubble guide pipe 29 was used. Therefore, Experiment 3 corresponds to a comparative example. Experiment 3 was conducted in the same manner as in Experiment 1 except that the spray device 1A with the bubble guide pipe 29 blocked was placed on the mass meter used in Experiment 1. Accordingly, in Experiment 3, the liquid L was water. In Experiment 3, the mass represented by the mass meter was recorded every 30 seconds from the start of the experiment, and the mass loss (g) was calculated. In Experiment 3, data for 10 minutes after the start of the experiment was obtained.

(Experiment 4)

Experiment 4 was conducted in the same manner as in Experiment 1 in which the same spray device as Experiment 3, i.e., the device corresponding to the spray device 1A substantially without the bubble guide pipe 29 was placed on the mass meter used in Experiment 1. Therefore, Experiment 4 also corresponds to a comparative example. In Experiment 4, the liquid L which was stored in the tank 36 was ethanol. In Experiment 4, as with Experiment 3, the mass represented by the mass meter was recorded every 30 seconds from the start of the experiment, and the mass loss (g) was calculated. In Experiment 4, data for 10 minutes after the start of the experiment was obtained.

(Experimental Result)

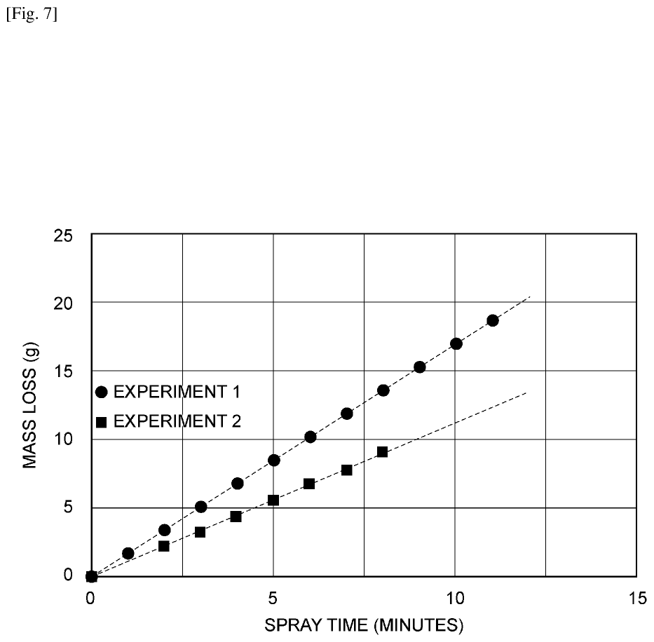

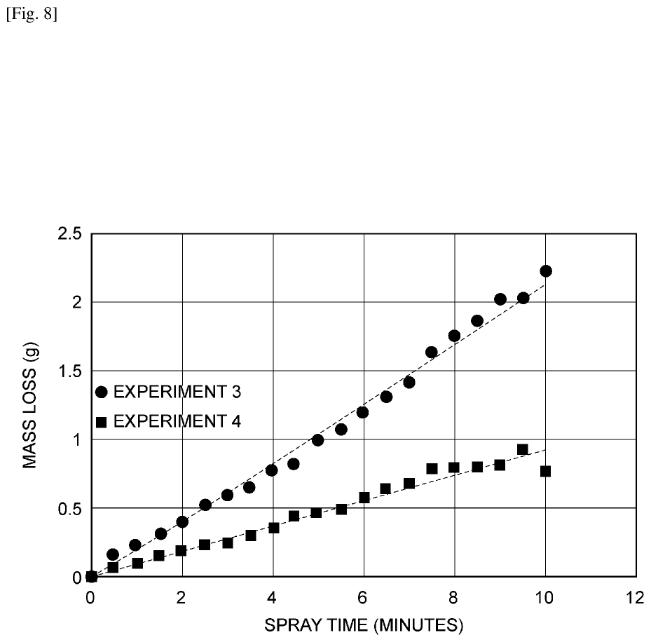

The results of Experiments 1 and 2 are shown in FIG. 7, and the results of Experiments 3 and 4 are shown in FIG. 8. The abscissa of FIGS. 7 and 8 shows time (in minutes). The ordinate of FIGS. 7 and 8 show mass loss (g).

Comparison between the results of Experiments 1 and 2, and the results of Experiments 3 and 4 show that mass loss (g) in Experiments 1 and 2 in which the bubble guide pipe 29 serves is larger than that in Experiments 3 and 4 in which the bubble guide pipe 29 is blocked does not serve. Therefore, the results show that in Experiments 1 and 2, more liquid L is sprayed. To confirm this numerically, linear fitting is performed for Experiments 1 to 4, and an approximate equation was calculated. The inclination of the linear expression obtained by linear fitting the experimental data of Experiments 1 to 4 represents the amount of spray per minute. The resulting spray amount was 1.70 g/min in Experiment 1, and 1.13 g/min in Experiment 2. On the other hand, the amount was 0.22 g/min in Experiment 3, and 0.09 g/min in Experiment 4. Thus, it was confirmed that in Experiments 1 and 3 where water was used as the liquid L, the spray amount was larger in Experiment 1, and in Experiments 2, and 4 where ethanol was used as the liquid L, the spray amount was larger in Experiment 2.

The differences between the results of Experiments 1 to 4 are believed to be due to the following reasons. In Experiments 3 and 4, the bubbles B occurring in the vicinity of the spray unit 16, as the experimental time elapses, stay in the vicinity of the spray unit 16, and block the supply of the liquid L to the spray unit 16. In Experiments 1 and 2, on the other hand, the operation of the bubble guide pipe 29 prevents the blockage of the supply of the liquid L to the spray unit 16 by the aforementioned bubbles B.

In Experiments 1 and 2, as shown in FIG. 7, mass loss is increased at a constant rate. In other words, the mass loss is increased linearly. On the other hand, in Experiments 3 and 4, as shown in FIG. 8, a variation in the rate of the increase in mass loss has occurred. It is believed that in Experiment 1 and 2, the bubbles B occurring in the spray unit 16 can be securely removed via the bubble guide pipe 29, while in Experiments 3 and 4, the bubbles B stay in the vicinity of the spray unit 16 and destabilize the supply of the liquid L to the spray unit 16.

It will be appreciated that from the results of Experiments 1 to 4 described above, by providing the bubble guide pipe 29, the bubbles B occurring in the vicinity of the spray unit 16 can be removed, and a constant amount of spray can be supplied stably.

### Second Embodiment

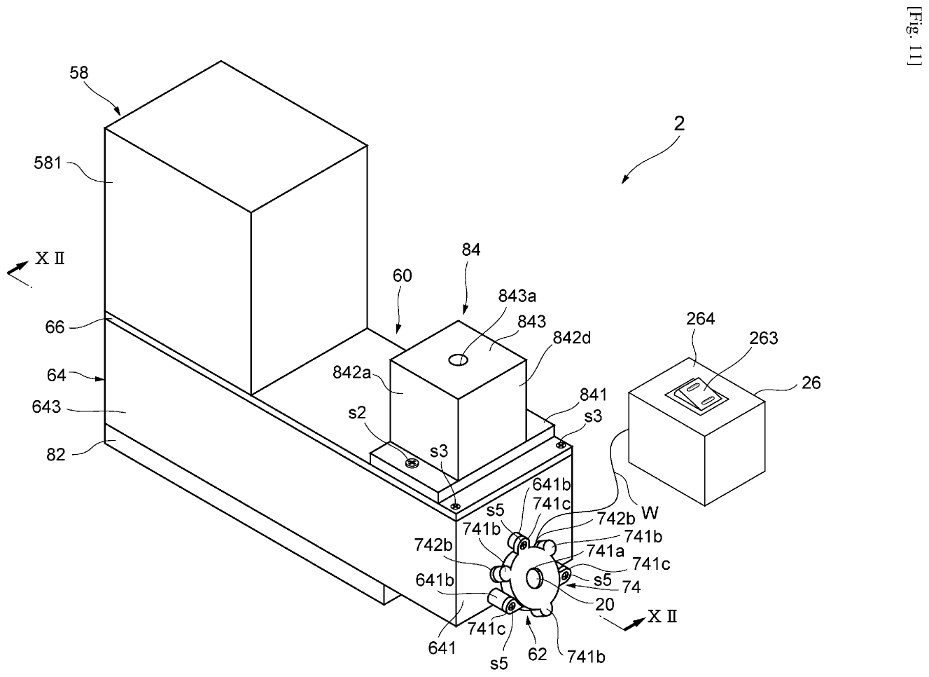

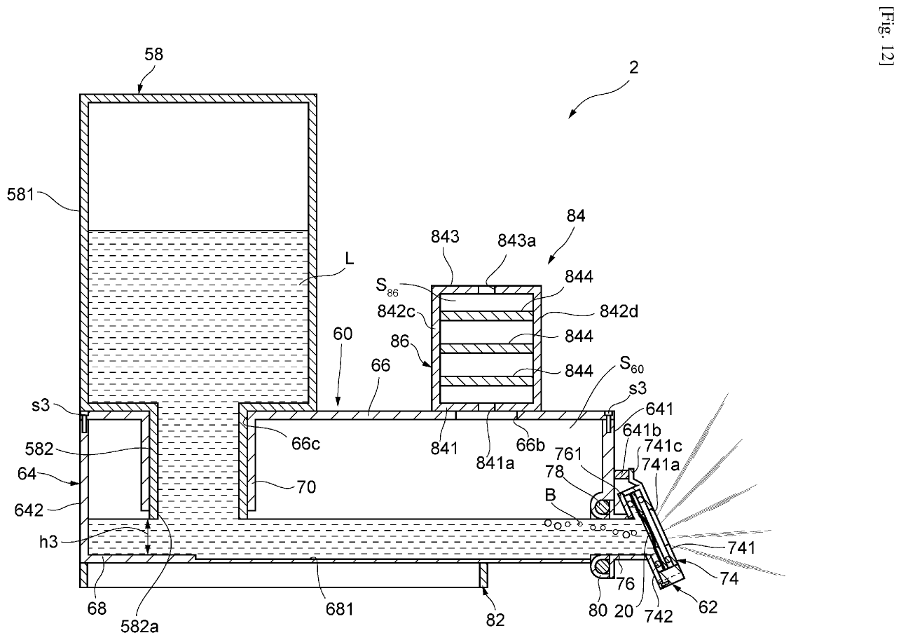

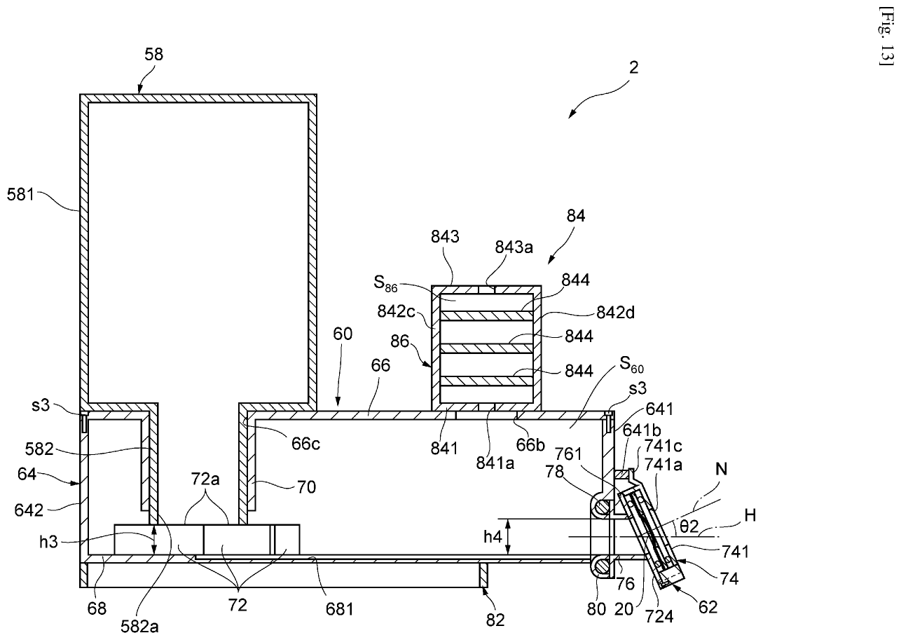

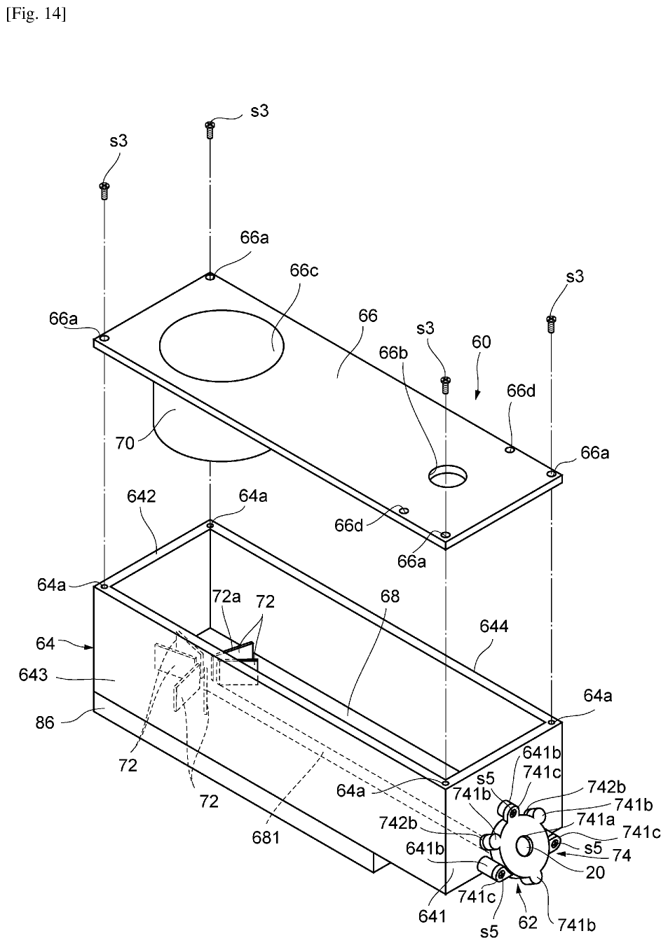

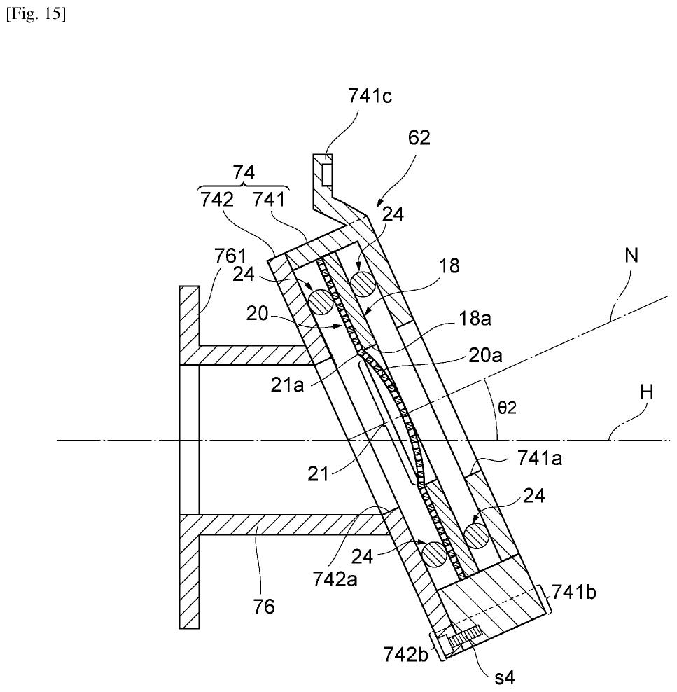

Next, a spray device according to the second embodiment will be described using FIGS. 11 to 15. FIG. 11 is a perspective view of a schematic configuration of a spray device 2 according to the second embodiment. FIG. 12 is a sectional view taken along line XII-XII of FIG. 11. FIG. 13 is a drawing in which the illustration of a liquid L is omitted from FIG. 12. FIG. 14 is an exploded perspective view of a chamber unit (liquid reservoir) of the spray device shown in FIG. 11. FIG. 14 shows a configuration in which the spray unit is attached to the liquid reservoir. FIG. 15 is a drawing for describing the configuration of the spray unit of the spray device shown in FIG. 11.

As schematically shown in FIGS. 11 to 13, the spray device 2 according to the second embodiment includes a liquid supply unit 58, a chamber unit 60, and a spray unit 62. The spray device 2 is a device in which the spray unit 62 sprays the liquid L which is supplied from the liquid supply unit 58 and stored in the chamber unit 60. Examples of liquid L may be the same as that in the first embodiment.

The liquid supply unit 58 includes a container which includes a square tube shaped body member 581 of which both ends are closed and a cylindrical member 582 provided at the one end of the body member 581, and supplies the liquid L in the body member 581 into the chamber unit 60 from the cylindrical member 582. An example of the container is a tank or a bottle. The material of the liquid supply unit 58 is not limited. For example, the same material as that of the tank body 44 of the first embodiment (specifically, resin) may be used. The one end of the body member 581 has an opening at a connection portion connected with the cylindrical member 582, thereby connecting the internal space of the cylindrical member 582 and the internal space of the body member 581. The liquid supply unit 58 is attached the chamber unit 60 such that the opening end 582a of the cylindrical member 582 opposite the body member 581 is positioned in the chamber unit 60.

Chamber unit 60 has a frame body 64, a top plate (upper wall) 66, and a bottom plate (bottom portion or bottom wall) 68. The chamber unit 60 has a box-like shape and is constituted such that each of the two openings located on opposite ends of the frame body 64 in the central axis direction thereof are closed by the top plate 66 and the bottom plate 68, respectively. The chamber unit 60 is a liquid reservoir for storing the liquid L supplied from the liquid supply unit 58. The material of the chamber unit 60 may be the same as the material of the chamber body 401 of the first embodiment.

The frame body 64 has four side walls 641, 642, 643, and 644, and the side walls 641, 642, 643, and 644 are integrally connected. The shape of a cross section perpendicular to the central axis of the frame body 64 is not limited, but it is rectangular in the second embodiment. The side wall 641 and the side wall 642 face to each other, and the side wall 643 and the side wall 644 face to each other.

The top plate 66 closes one opening end of the frame body 64 in the central axis direction of the frame body 64. The top plate 66 in the second embodiment is detachably fixed to frame body 64, and serves as a lid. A method for fixing the top plate 66 to the frame body 64 is not particularly limited. For example, as shown in FIGS. 12 to 14, the top plate 66 may be screwed by screws s3 to the frame body 64. In this configuration, the top plate 66 may have insertion holes 66a through which screws s3 (see FIG. 14) pass, and the frame body 64 may have screw holes 64a for receiving the screws s3. Alternatively, the top plate 66 may be fitted to the frame body 64, or may be joined to the frame body 64 with an adhesive. Further, the top plate 66 may be integrally molded with the frame body 64.

As shown in FIGS. 12 to 14, the top plate 66 has two openings 66b, and 66c. The internal space S₆₀ in the chamber unit 60 is opened to atmosphere through the opening 66b. Therefore, the chamber unit 60 is also an atmospheric air release unit. Size of the opening 66b is not limited as long as the internal space S₆₀ is opened to atmosphere through the opening 66b. Preferably the opening 66b has a size such that the liquid L stored in the chamber unit 60 hardly leaks.

The opening 66c, as shown in FIGS. 12 and 13, is a hole for inserting the cylindrical member 582 which the liquid supply unit 58 has into the chamber unit 60. The inner diameter of the opening 66c is not limited as long as it is larger than the outer diameter of the cylindrical member 582, but it is substantially equal to the outer diameter of the cylindrical member 582 in the second embodiment. The opening 66c is integrally provided with a cylindrical guide unit 70 for guiding the cylindrical member 582 toward the bottom plate 68. The length of the guide unit 70 (length of the top plate 66 in the thickness direction) is shorter than the distance between the bottom plate 68 and the top plate 66. The inner diameter of the guide unit 70 may be substantially the same as the outer diameter of the cylindrical member 582 of the liquid supply unit 58.

As shown in FIGS. 12 to 14, the bottom plate 68 blocks the other opening end of the frame body 64, i.e., the opening end opposite the one opening end blocked by the top plate 66. The frame body 64 is integrally provided with the bottom plate 68. In other words, four side walls 641, 642, 643, and 644 of the frame body 64 is integrally installed upright on the four edges of the bottom plate 68. In the second embodiment, the angle between the bottom plate 68 and the side walls 641, 642, 643, and 644 is substantially 90°. However, as long as the chamber unit 60 which can store the liquid L is configured, the angle between the bottom plate 68 and the side walls 641, 642, 643, and 644 is not limited to 90°.

The bottom plate 68 has a recess 681 which is continuous toward the side wall 641 from a position under the opening end 582a of the cylindrical member 582 in the vertical direction (specifically, from a region facing the opening end 582a). Around the end portion of the recess 681 opposite the side wall 641, the five spacers 72 for supporting the opening end 582a of the cylindrical member 582 are installed upright. The spacers 72 are plate-like members, and the five spacers 72 are spaced to each other around the central axis of the cylindrical member 582 (or the guide unit 70). With this configuration, when the liquid supply unit 58 is attached to the chamber unit 60, the opening end 582a of the cylindrical member 582 is in contact with the upper end 72a of the spacer 72, and is spaced from the bottom plate 68. In the second embodiment, the distance h3 between the opening end 582a, and the upper surface of the bottom plate 68 is equal to the height of the spacers 72 (length in the thickness direction of the bottom plate 68).

In the above configuration, the distance h3 between the opening end 582a and the bottom plate 68 is adjusted by the spacers 72. Therefore, although in FIGS. 11, 12 and 13, as an example, the length of the cylindrical member 582 is the same as the distance between the upper surface of the top plate 66 and the spacers 72, the length of the cylindrical member 582 may be not less than a distance between the upper surface of the top plate 66 and the spacers 72.

The second embodiment shows an example in which the recess 681 is formed in the bottom plate 68. However the recess 681 may not be formed in the bottom plate 68. The second embodiment shows an example in which the five spacers 72 are installed upright on the bottom plate 68. However, it is enough that at least one spacer 72 is provided. Further, for example, as shown in FIGS. 11, 12 and 13, when the body member 581 is configured to be in contact with the upper surface of the top plate 66, no spacer 72 may be provided. This is because the distance h3 can be defined (or secured) by adjusting the length of the cylindrical member 582. For example, protrusions instead of the spacers 72 may be formed on the bottom plate 68.

In the above configuration, the liquid supply unit 58 is attached to the chamber unit 60 by inserting the cylindrical member 582 into the opening 66c and the guide unit 70. In this case, for example, the guide unit 70 and the cylindrical member 582 may be configured to be screwed to each other.

The liquid leakage prevention mechanism may be provided in order to prevent the liquid leakage when the liquid supply unit 58 is attached to the chamber unit 60. The liquid leakage prevention mechanism may be configured such that, for example, the opening end 582a is sealed with a seal member, and when the opening end 582a is attached to the chamber unit 60, the seal member is broken, and the liquid L in the liquid supply unit 58 flows into the chamber unit 60. Alternatively, the liquid leakage prevention mechanism may be configured such that a cap having a valve function is provided on the opening end 582a of the cylindrical member 582, and when the liquid supply unit 58 is attached to the chamber unit 60, the valve opens, and the liquid L in the liquid supply unit 58 flows into the chamber unit 60.

The spray unit 62, which is provided on the side wall 641 of the chamber unit 60, atomizes the liquid L supplied from the chamber unit 60 and discharges to the outside of the spray device 2. Still referring to FIG. 15, an example of the configuration of the spray unit 62 will be described. FIG. 15 shows a cross-sectional configuration of a piezoelectric spray unit as an example of the spray unit 62. In FIG. 15, the connection pipe 76 to allow the liquid L in the chamber unit 60 to flow into the spray unit 62 is also shown.

As shown in FIG. 15, the spray unit 62, as with the spray unit 16, includes a piezoelectric transducer (ultrasonic transducer) 18 having an opening 18a, and a vibration plate 20 having a plurality of through holes 20a. The piezoelectric transducer 18 and the vibration plate 20 are housed in the casing 74. The spray unit 62 illustrated in FIG. 15 is attached to the side wall 641 on the vibration plate 20 side relative to the piezoelectric transducer 18. That is, the liquid L flows into the spray unit 62 from the vibration plate 20 side.

The configuration of the spray unit 62 is the same as that of the spray unit 16 except that the configuration of the casing 74 differs from that of the casing 22 of the spray unit 16. Accordingly, the description of the piezoelectric transducer 18 and the vibration plate 20 will be omitted.

The casing 74 includes a casing body 741 and a lid 742. The casing body 741 has a bottomed tubular shape, and the lid 742 is fixed to the casing body 741 so as to block the opening end of the casing body 741. Thus, the housing space for housing the piezoelectric transducer 18 and the vibration plate 20 is formed in the casing 74. In the second embodiment, the opening end of the casing body 741 is circular, and the lid 742 is disk-shaped.

In the bottom portion of the casing body 741 and the lid 742, the opening 741a and the opening 742a are formed in an area corresponding to (or facing) the opening 18a of the piezoelectric transducer 18. The opening 741a serves as the spray port of the liquid L, and the opening 742a serves as an introduction port for introducing the liquid L into the casing 22.

In the second embodiment, the casing body 741 and the lid 742 are fixed to each other by screws. As shown in FIGS. 11, 14, and 15, in the circumferential wall of the lid 742, the screw supporting portion 742b which supports screws s4 discretely positioned is provided such that the screw supporting portion 742b extends outward. On the other hand, in the circumferential wall of the casing body 741, the screw receiving portion 741b which receives the screws s4 and is screwed with the screws s4 is provided in areas corresponding to the screw supporting portion 742b such that the screw supporting portion 742b extends outward. Thus, the lid 742 is fixed to the casing body 741 such that screws s4 pass through the screw supporting portion 742b, and are screwed into the screw receiving portion 741b. However, a method of fixing the casing body 741 and lid 742 is not limited as long as they are fixed. A preferable fixing method is that the piezoelectric transducer 18 and the vibration plate 20 are detachable for their replacement.

The piezoelectric transducer 18 and the vibration plate 20, which are held by a pair of elastic rings 24, are housed in the casing 74. One elastic ring 24 of the pair of elastic rings 24 is coaxial with the piezoelectric transducer 18 and the vibration plate 20 between the piezoelectric transducer 18 and the bottom portion of the casing body 741, and the other elastic ring 24 is coaxial with the piezoelectric transducer 18 and the vibration plate 20 between the vibration plate 20 and the lid 742. Since the material of the elastic ring 24 and the like are the same as those in the first embodiment, the description thereof will be omitted.

As shown in FIG. 11, the spray unit 62 is electrically connected through wiring W to the drive unit 26 for driving the spray unit 62. Therefore, the casing 74 has a hole for allowing the wiring W to pass through. The configuration of the drive unit 26 is the same as that in the first embodiment, and includes the power supply 261, the drive circuit 262, and the switch 263. In FIGS. 12 and 13, the illustration of the drive unit 26 is omitted.

Although an example of the configuration of the spray unit 62 is specifically described, the spray unit 62 may be any known piezoelectric spray unit. The configuration of the spray unit 62 may be the same as that of the spray unit 16.

As shown in FIGS. 12, 13, and 15, the spray unit 62 is provided on the side wall 641 via the connection pipe 76, and the connection pipe 76 communicates with the internal space S₆₀ in the chamber unit 60. In the second embodiment, the connection pipe 76 is provided on the side wall 641 such that its central axis is in the horizontal plane H. Specifically, the connection pipe 76 is provided on the side wall 641 so that the central axis of the connection pipe 76 is coincident with the thickness direction of the side wall 641. The shape of the connection pipe 76 is not limited, but it has a cylindrical shape in the second embodiment. The connection pipe 76 serves as a liquid passage (or liquid flow path) for allowing the liquid L in the chamber unit 60 to flow into the spray unit 62.

The liquid outlet side end portion of the connection pipe 76 is connected to the lid 742. The end surface of the liquid outlet side end portion of the connection pipe 76 (hereinafter also referred to as “liquid outlet side end surface”) is inclined with respect to the central axis of the connection pipe 76 or the horizontal plane H. Specifically, the liquid outlet side end surface of the connection pipe 76 is inclined such that normal N of the liquid outlet side end surface has an angle of θ2 with respect to the horizontal plane H. The angle θ2 may be 0° to 90°. In the second embodiment, the angle θ2 is greater than 0°, such as about 30°.

The liquid outlet side end portion of the connection pipe 76 is connected to the opening 742a of the lid 742, and the inner diameter of the liquid outlet of the connection pipe 76 is substantially the same as the inner diameter of the opening 742a. However, as long as the liquid outlet side end portion of the connection pipe 76 is connected to the opening 742a of the lid 742, the inner diameter of the liquid outlet at the end of the connection pipe 76 may be different from the inner diameter of the opening 742a.

In FIGS. 11 to 14, as an example, the embodiment is shown in which the spray unit 62 is fixed to the side wall 641 with screw. In this case, the screw supporting portion 741c which extends outwardly in the radial direction and supports screws s5 (see FIG. 11 and FIG. 14) are provided on the outer periphery of the casing body 741 of the casing 74. On the side wall 641, the screw receiving portion 641b is formed in a region facing the screw supporting portion 741c. Thus, the spray unit 62 is fixed to the side wall 641 such that the screws s5 pass through the screw supporting portions 741c, and are screwed into the screw receiving portions 641b.

As shown in FIGS. 12 and 13, the housing unit 80 for housing the seal member 78 such as an O-ring is formed on a periphery of the connection portion of the connection pipe 76 and the side wall 641, and inside of the side wall 641. The seal member 78 is pressed by a pressing member (or flange member) 761 (see FIGS. 12, 13, and 15) provided on the liquid inlet side periphery of the connection pipe 76, when the spray unit 62 is fixed to the side wall 641. Accordingly, the prevention of liquid leakage at the connecting portion of the connection pipe 76 and the side wall 641 is achieved.

In FIGS. 12 and 13, the connection pipe 76 is connected to the side wall 641 on the bottom plate 68 side (in the vicinity of the end of the side wall 641 on the bottom plate 68 side), and the housing unit 80, in the second embodiment, has an annular shape. Therefore, a portion of the housing unit 80 extends outwardly from the bottom plate 68. Thus, upon installing the spray device 2 to a predetermined location, a chamber support member 82 is provided on the outer surface of the bottom plate 68 so that the bottom plate 68 keeps the horizontal state (or a state orthogonal to the vertical direction). Although the chamber support member 82 has a frame shape in the second embodiment, its shape is not limited as long as the chamber support member 82 supports the chamber unit 60 horizontally.

As shown in FIG. 11, the spray device 2 further includes the liquid leakage prevention unit (liquid leakage prevention mechanism) 84. The embodiment in which the liquid leakage prevention unit 84 is provided will be described. In this case, the liquid leakage prevention unit 84 is fixed to the upper surface of the top plate 66 so as to block the opening 66b of the chamber unit 60. In the embodiment illustrated in FIG. 11, the liquid leakage prevention unit 84 is fixed to the chamber unit 60 by screws s2. Thus, as illustrated in FIG. 14, screw holes 66d which are screwed with the screw s2 are formed in the liquid leakage prevention unit 84 on the top plate 66 such that the liquid leakage prevention unit 84 is fixed to the chamber unit 60 by screw.

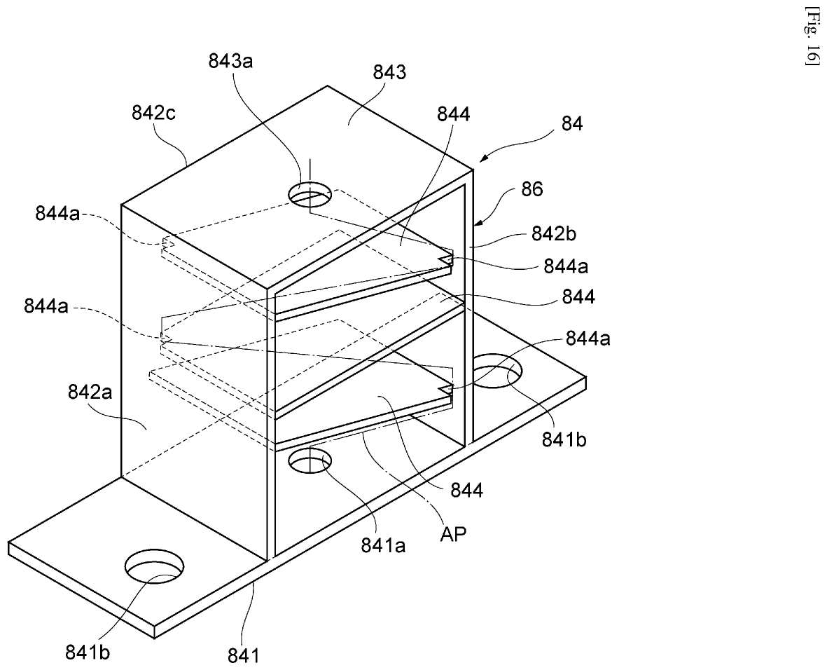

With reference to FIGS. 11, 12, 13, and 16, an example of the configuration of the liquid leakage prevention unit 84 will be described. The liquid leakage prevention unit 84 includes a bottom plate 841, four side walls 842a, 842b, 842c, and 842d, a top plate 843, and a plurality of partition plates 844. In FIG. 16, for the description of the internal structure of the liquid leakage prevention unit 84, the illustration of the side wall 842d is omitted.

The bottom plate 841 has a flat plate shape, and extends in one direction. The bottom plate 841 has a through hole (first through hole) 841a penetrating the bottom plate 841 in the thickness direction. The through hole 841a is formed at a position facing the opening 66b when the liquid leakage prevention unit 84 is attached to the chamber unit 60. The bottom plate 841 has a through hole 841b through which screws s2 pass in the vicinity of both end portions of the bottom plate 841 in the longitudinal direction wherein the screws s2 are used for screwing the liquid leakage prevention unit 84 to the chamber unit 60.

As shown in FIG. 16, one pair of the side walls 842a and 842b facing each other out of the four side walls 842a, 842b, 842c, and 842d of the liquid leakage prevention unit 84 are installed upright on the opposite sides of the through hole 841a of the bottom plate 841 in the longitudinal direction. The other pair of opposing side walls 842c and the 842d out of the four side walls 842a, 842b, 842c, and 842d connects the one pair of the side walls 842a, and 842b.

The top plate 843 is disposed to face the bottom plate 841, and is fixed to the opposite ends of the side walls 842a, 842b, 842c, and 842d with respect to the bottom plate 841. The top plate 843 has a through hole (second through hole) 843a penetrating the top plate 843 in the thickness direction.

The four side walls 842a, 842b, 842c, and 842d, a portion of the bottom plate 841, wherein the portion is sandwiched by a pair of the side walls 842a, and 842b, and the top plate 843 constitute a housing unit 86 for housing a plurality of partition plates 844.

The plurality of partition plates 844 are disposed in the vertical direction. Each partition plate 844 spans the pair of the side walls 842a and 842b, and has the same width as the length between the pair of the side walls 842c and 842d. The partition plates 844 and 844 adjacent to each other in the vertical direction are disposed to be inclined in the opposite direction to each other with respect to the vertical direction.

A notch portion 844a in the one of the four corners of each partition plate 844 is formed. When viewed in the vertical direction, the positions of the notch portions 844a of the partition plates 844 adjacent to each other in the vertical direction are different. Each notch portion 844a is formed at the corner portion of the partition plate 844, so that a hole is formed by the inner surface of the housing unit 86 and each notch portion 844a. Each notch portion 844a serves as a region connection path connecting the regions on both sides of the partition plate 844.

The liquid leakage prevention unit 84 with the above configuration houses the three partition plates 844 in a housing space (internal space) S₈₆ of the housing unit 86. The housing space S₈₆ is partitioned by three partition plates 844 into four regions in the vertical direction. As schematically shown by a dot-and-dash line in FIG. 16, an air path AP through which atmospheric air (air) passes into the opening 66b is formed by the notch portions 844a formed in the partition plates 844, together with the through hole 841a and the through hole 843a. Accordingly, although the liquid leakage prevention unit 84 provided on the chamber unit 60 blocks the opening 66b of the chamber unit 60, the opening 66b communicates with atmosphere by the air path AP. As a result, the chamber unit 60 is opened to atmosphere. Since the air path AP is formed so as to connect the notch portions 844a as a region connection path formed in the partition plates 844, so that the air path AP is bent at each partition plate 844.

In the spray device 2, when the liquid supply unit 58 is attached to the chamber unit 60, liquid L flows into the chamber unit 60 from the liquid supply unit 58. The spray unit 62 is attached to the side walls 641 constituting the chamber unit 60, and the spray unit 62 and the inside of the chamber unit 60 are connected via a connection pipe 76. Therefore, the liquid L inside the chamber unit 60 is supplied to the spray unit 62. In this state, when the switch 263 of the drive unit 26 is turned on and a high-frequency voltage is supplied to the piezoelectric transducer 18, the piezoelectric transducer 18 ultrasonically vibrates in the radial direction. The ultrasonic vibration causes the vibration plate 20 to ultrasonically vibrate in its thickness direction. This ultrasonic vibration causes the liquid L in contact with the vibration plate 20 having the plurality of through holes 20a to be atomized and sprayed from the spray unit 62 (specifically, the opening 741a) to the outside of the spray device 2. In the spray device 2, since the liquid L is directly supplied to the spray unit 62, more liquid L can be sprayed from the spray unit 62.

The spray unit 62 is provided on the side wall 641 via a connection pipe 76. The liquid outlet side end surface of the connection pipe 76 is inclined such that its normal N has an angle of 02 with respect to the horizontal plane H, and the spray unit 62 is provided at the liquid outlet side end of the connection pipe 76. Therefore, the liquid L is sprayed from the spray unit 62 in the direction with an angle of θ2 with respect to the horizontal plane H. In the second embodiment, since the angle θ2 is greater than 0° such as 30°, the liquid L is sprayed obliquely upward with respect to the horizontal plane H.

The liquid L is supplied into the chamber unit 60 from the liquid supply unit 58. The opening end 582a of the cylindrical member 582 which the liquid supply unit 58 has is located inside the chamber unit 60, and protrudes toward the bottom plate 68 from the end portion of the guide unit 70 on the bottom plate 68 side. Therefore, the liquid L is supplied to the chamber unit 60 from the opening end 582a. Thus, the cylindrical member 582 serves as a liquid supply path for supplying the liquid L to the chamber unit 60, and the opening end 582a facing the bottom plate 68 (in other words, opposite the bottom plate 68) serves as a liquid supply port.

When the liquid L flows into the chamber unit 60 from the liquid supply unit 58, since the inside of the chamber unit 60 is opened to atmosphere through the opening 66b, the liquid level height inside the chamber unit 60 (in other words, the amount of the liquid L) is kept at a distance h3 between opening end 582a and the upper surface of the bottom plate 68. This is because when the liquid level height inside the chamber unit 60 becomes lower than the opening end 582a, the air flows from the chamber unit 60 to the liquid supply unit 58, while the liquid L flows into the chamber unit 60 from the liquid supply unit 58 such that the chamber unit 60 is filled with the liquid L up to the level of the opening end 582a. Therefore, in the second embodiment, the peripheral wall of the cylindrical member 582 serves as a liquid level keeping wall. The liquid L rises in vicinity of the opening end 582a slightly vertically upward along the outer surface of the cylindrical member 582 under the influence of surface tension to form a so-called fillet. Therefore, in practice, when the uppermost end of the fillet which rises along the outer surface of the cylindrical member 582 vertically upward due to surface tension falls below the opening end 582a, the liquid L flows from the liquid supply unit 58 into the chamber unit 60.

As described above, since the peripheral wall of the cylindrical member 582 serves as the liquid level keeping wall, the liquid level height of the liquid L stored in the chamber unit 60 is naturally kept at the distance h3. Accordingly, a constant amount of the liquid L is stored in the chamber unit 60. As a result, since the fluctuation of the liquid pressure applied to the spray unit 62 is suppressed, stable spraying is further achieved.

Since the liquid level height of the liquid L stored in the chamber unit 60 is automatically kept at a distance h3 between the opening end 582a and the bottom plate 68, the water pressure sensor or the like is not necessary for applying a constant liquid pressure to the spray unit 62. That is, the spray device 2 has a configuration in which liquid pressure management is easy. Further, since the liquid pressure management can be conducted by a location of the opening end 582a, liquid pressure management can be conducted at low cost.

The position of the opening end 582a may be set at a height of the upper end 21a of the spray area 21 or higher in the vertical direction (see FIGS. 13 and 15). Thereby, the height of the position of the upper end 21a of the spray area 21 in the vertical direction is the same as or lower than that of the liquid surface in the vertical direction. Therefore, since the liquid L is securely supplied to the spray area 21, stable spraying can be achieved. For example, as shown in FIGS. 12 and 13, the distance h3 may be set to a distance which is substantially equal to or more than the distance h4 between the upper end 21a of the spray area 21 of the vibration plate 20 and the upper surface of the bottom plate 68 in the vertical direction in a state where the upper surface of the bottom plate 68 is parallel to the horizontal plane H.

In an operation of the spray unit 62, the pressure drop in the liquid L in the vicinity of the vibration plate 20 may occur with the ultrasonic vibration of the vibration plate 20, and the bubbles B may occur in the vicinity of the spray unit 62. Alternatively, gas from the outside by the vibration of the vibration plate 20 may enter the spray device 2, and the bubbles B may occur in the vicinity of the spray unit 62.

Since the spray unit 62 is attached to the side wall 641 of the chamber unit 60, when the bubbles B occur in the vicinity of the spray unit 62 (see FIG. 12), the bubbles B flow into the chamber unit 60. Since the internal space S₆₀ of the chamber unit 60 is opened to atmosphere through the opening 66b, the bubble B which has returned to the chamber unit 60 is discharged from the liquid surface of the liquid L stored in the chamber unit 60 to atmosphere. Therefore, the bubble B is unlikely to stay in the vicinity of the spray unit 62. Therefore, as with the first embodiment, the liquid L can be sprayed stably from the spray unit 62.

Liquid pressure applied to the spray unit 62 depends on the amount of the liquid L to be positioned above the spray unit 62 (specifically, above the center position of the vibration plate 20 in the vertical direction). In the configuration of the spray device 2, the spray unit 62 is mounted on the side wall 641 of the chamber unit 60 (more specifically, the side wall 641 on the bottom plate 68 side). Therefore, as compared with the configuration in which the spray unit 62 is arranged vertically below the chamber unit 60, the liquid pressure applied to the spray unit 62 can be reduced. As a result, when the spray unit 62 of the spray device 2 is in non-operating state, i.e., in a state where no liquid L is sprayed, liquid leakage is unlikely to occur from the spray unit 62.

Setting the distance h3 between the opening end 582a of the liquid supply unit 58 and the bottom plate 68 of the liquid supply unit 58 (i.e., the height of the spacers 72) to a value at which liquid leakage does not occur in the spray unit 62 when the spray unit 62 is in non-operating state (i.e., in a state where no liquid L is sprayed) can securely prevent the liquid from leaking when the spray unit 62 is in non-operating state. The distance h3 is set depending on, for example, the density of the liquid L to be used, and the degree of unlikeliness of leakage of the liquid L in the through hole 20a of the vibration plate 20. “The degree of unlikeliness of leakage of the liquid L in the through hole of the vibration plate 20” depends on the size of the through hole 20a of the vibration plate 20 and surface tension of the liquid L. As described above, in the second embodiment, the distance h3 is substantially equal to the distance h4 between the upper end 21a of the spray area 21 of the vibration plate 20 and the upper surface of the bottom plate 68 in the vertical direction. Therefore, when the distance h3 is set such that the liquid leakage does not occur, the size and installation conditions of the spray unit 62 may be adjusted such that the distance h4 is equal to the distance h3.

In the spray device 2, the recess 681 is formed in the bottom plate 68. The recess 681 extends toward the side wall 641 from the region facing the opening end 582a of the liquid supply unit 58. Since the spray unit 62 is attached to the side walls 641, the liquid L which is supplied from the liquid supply unit 58 into the chamber unit 60, and stored in the chamber unit 60 is guided by the recess 681, and tends to flow toward the spray unit 62. Thus, the liquid L can be securely supplied to the spray unit 62.

The spray device 2 includes the liquid leakage prevention unit 84. The configuration of the liquid leakage prevention unit 84 is the same as that of the liquid leakage prevention unit 54 of the first embodiment, except that the bottom plate 841, the top plate 843 and the partition plate 844 have no curved area. Accordingly, the operations and effects of the liquid leakage prevention unit 84 which the spray device 2 is provided with is the same as those of the liquid leakage prevention unit 54.

Next, with the spray device according to the second embodiment, what makes the stable spraying possible will be specifically described using the experimental results of Experiment 5 to Experiment 6.

(Experiment 5)

In Experiment 5, the spray device 2 having the embodiment illustrated in FIG. 11 was used. Therefore, Experiment 5 corresponds to an example. In Experiment 5, and the liquid L which was stored in the liquid supply unit 58 was water. In Experiment 5, with the spray device 2 placed on a mass meter (electronic balance BP221S made by Sartorius AG), the spray device 2 was run, and the liquid L was continuously sprayed from the spray unit 62. Then, the mass represented by the mass meter at the start of the experiment, and every 30 seconds from the start of the experiment was recorded, and the difference between a mass at the beginning of the experiment and a mass measured at each predetermined elapse time was calculated as a mass loss (g). In Experiment 5, data for 10 minutes after the start of the experiment was obtained.

(Experiment 6)

Experiment 6 was conducted in the same manner as in Experiment 5 in which the same spray device 2 as in Experiment 5 was placed on the mass meter used in Experiment 5. Therefore, Experiment 6 also corresponds to an example. In Experiment 6, the liquid L which was stored liquid supply unit 58 was ethanol. In Experiment 6, the mass represented by the mass meter at the start of the experiment, and every 30 seconds from the start of the experiment was recorded, and the difference between a mass at the beginning of the experiment and a mass measured at the predetermined elapse time was calculated as a mass loss (g). In Experiment 6, data for 10 minutes after the start of the experiment was obtained.

(Experimental Result)

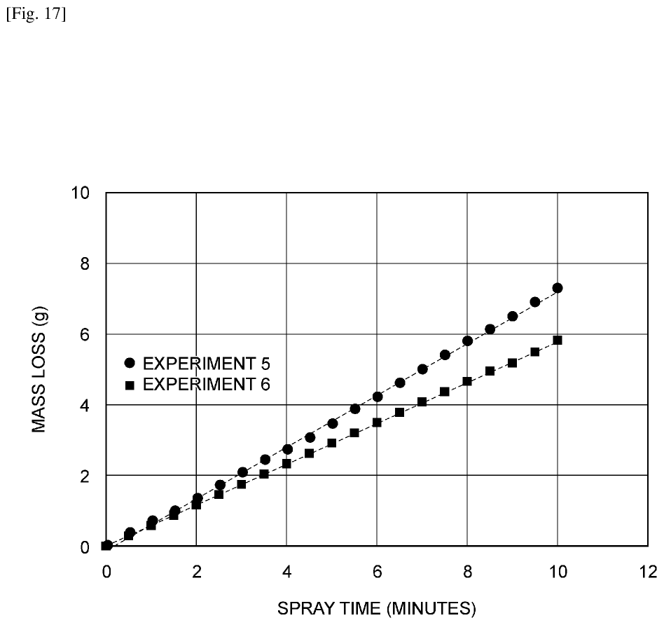

The results of Experiments 5 and 6 are shown in FIG. 17. The abscissa of FIG. 17 shows time (in minutes). The ordinate of FIG. 17 shows mass loss (g).

In Experiments 5 and 6, as shown in FIG. 17, mass loss is increased at a constant rate. In other words, the mass loss is increased linearly. It is believed that the bubbles B occurring in the spray unit 16 can be securely removed by the chamber unit 60. Linear fitting is performed for the results of the Experiments 5 and 6, and an approximate equation was calculated. The inclination of the linear expression obtained by linear fitting the experimental data of Experiments 5 to 6 represents the amount of spray per minute. The resulting spray amount was 0.73 g/min in Experiment 5, and 0.58 g/min in Experiment 6.

It will be appreciated that from the results of Experiments 5 to 6 described above, by the chamber unit 60, the bubbles B occurring in the vicinity of the spray unit 62 can be removed, and a constant amount of spray can be supplied stably.

Having described various embodiments of the present invention, the present invention is not limited to the various embodiments illustrated, and the scope of the present invention is defined by the claims described below. It is intended that the scope of the present invention includes equivalents of the claims and all modifications within the scope of the claims.

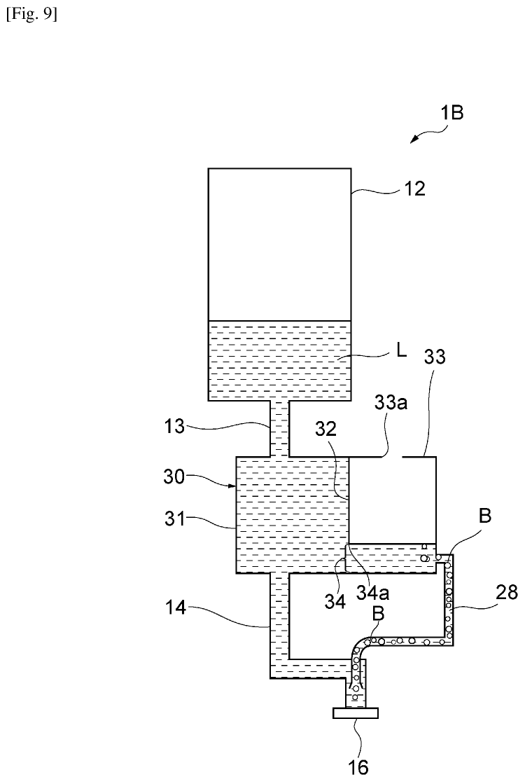

For example, the embodiment is mainly described in which the spray unit 16 sprays the liquid L in the direction forming an angle of θ1 (θ1 is not less than 0° and no greater than 90°) with respect to the horizontal plane (or horizontal direction) H. As in the spray device 1B shown in FIG. 9, the spray unit 16 may spray the liquid L vertically downward. FIG. 9 shows an example of the configuration of the spray device when spraying the liquid downwards. In the spray device 1B, the liquid supply path 14 is formed such that the liquid L can be sprayed downward from the spray unit 16 in the vertical direction, and the spray unit 16 is attached to the end portion of the liquid outlet of the liquid supply path 14.

The configuration of the spray device 1B is substantially the same as that of the spray device 1 except that the spray direction of the liquid L by the spray unit 16 differs. In the case in which the liquid L is sprayed vertically downward from the spray unit 16, the bubble guide path 28 may be connected to the liquid supply path 14 so that bubbles B occurring in the vicinity of the spray unit 16 can be efficiently collected.

For example, as shown in FIG. 9, the end portion of the bubble guide path 28 on the liquid supply path 14 side is inserted into the liquid supply path 14, and may be placed directly above and in the vicinity of the spray unit 16. At this time, when the end portion of the bubble guide path 28 is formed into a trumpet-shape which is widened on the spray unit side, the bubble B likely to flow into the bubble guide path 28. The configuration of the spray device 1B is substantially the same as that of the spray device 1 except that the spray direction of the liquid L by the spray unit 16 differs. Thus, the spray device 1B has the same actions and effects as the spray device 1. The spray device 1B may have a liquid leakage prevention unit 54 as with the spray device 1A.

In the configuration such as the spray device 1B, it is preferable to employ a liquid L having a thixotropic feature from the viewpoint of preventing liquid leakage from the spray unit 16 during non-operation of the spray unit 16. Alternatively, for example, from the viewpoint of preventing leakage of liquid during non-operation of the spray unit 16, the spray device 1B may have a shutter mechanism for closing the opening 222a during non-operation of the spray unit 16.

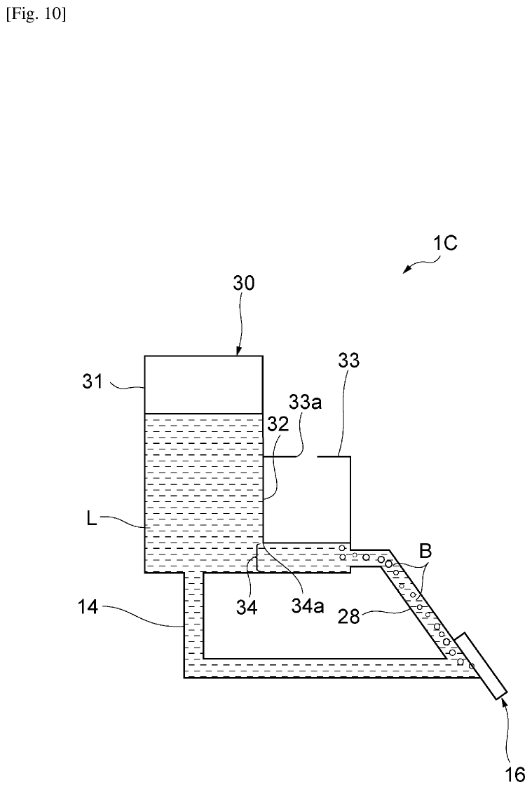

The spray device 1 has the configuration in which the liquid supply unit 12 is attached to the liquid reservoir 30, i.e., the liquid supply unit 12 is provided. However, like the spray device 1C shown in FIG. 10, the spray device 1C may not have the liquid supply unit 12.

Since the spray device 1C includes the bubble guide path 28 and the second chamber 33, as with the spray device 1, the bubbles B occurring in the vicinity of the spray unit 16 can be efficiently removed, and stable spraying can be achieved. In addition, the liquid supply unit 12 and the second chamber 33 are partitioned by the partition wall 32, and the liquid passage 34 is formed in the lower portion of the partition wall 32. Therefore, as with the spray device 1, the liquid level height of the liquid L in the second chamber 33 can be kept at the height of the upper end 34a of the liquid passage 34 on the second chamber 33 side. As a result, in the spray device 1C, as with the spray devices 1 and 1A, liquid pressure at the spray unit 16 can be kept constant. Thus, further stable spraying can be achieved. As with the spray device 1A, the spray device 1C may have the liquid leakage prevention unit 54. In addition, as shown in FIG. 9, the spray device 1C may be configured to spray the liquid L downward from the spray unit 16 in the vertical direction.

The spray device 1B and the spray device 1C as modifications of the spray device 1 have been described. The same modifications can also be applied to the spray device 1A.

While, in the second embodiment, the liquid supply unit is attached detachably to the chamber unit 60, which is a liquid reservoir, the liquid reservoir and the liquid supply unit may be configured not to separate each other. In this case, for example, a resupply port for resupplying the liquid into the liquid supply unit may be provided on the opposite side of the liquid reservoir.

In the second embodiment, the configuration is described in which the opening end 582a of the cylindrical member 582 protrudes from the guide unit 70 toward the bottom plate 68 side. However, the opening end 582a may not protrude from the guide unit 70 on the bottom plate 68 side. In this case, the liquid L from opening end of the guide unit 70 on the bottom plate 68 side is supplied to the chamber unit 60 as an atmospheric air release unit. Therefore, the guide unit 70 also serves as part of the liquid supply unit, and the opening end of the guide unit 70 on the bottom plate 68 side serves as a liquid supply port. In the second embodiment, it is not necessary to provide the guide unit 70.

The partition plates 544 and 844 of the liquid leakage prevention units 54 and 84, which are illustrated in FIGS. 3, 4, 6, 11, 12, 13, and 16, have at their corner portions respective notch portions 544a and 844a, which serve as a region connection path. However, as long as each notch portion 544a and 844a of the respective adjacent partition plates 544 and 844 are formed at different positions when viewed in the vertical direction, the position of each notch portion 544a and 844a are not limited to the corner portion.

In the configuration where the liquid leakage prevention unit has the partition plates which are housed in the housing unit, each partition plate may have a through hole penetrating the partition plate in the thickness direction, instead of having the notch portion. In this case, the through hole serves as a region connection path. Preferably, the number of partition plates housed in the housing unit is more than one in view of preventing liquid leakage. However its number may be one. In this case, the region connection path formed in the partition plate may be formed at a different position from the virtual straight line connecting the first and second through holes formed in the housing unit. This is because with such a configuration the air path AP is bent or curved once.

The configuration of liquid leakage prevention unit is not limited to the configuration described using FIG. 6 as long as the inside of the liquid reservoir is configured to be opened to atmosphere. In order to prevent liquid leakage effectively, it is preferable that the air path AP curved at least once is formed in the liquid leakage prevention unit. More preferably, the air path AP is bent or curved a plurality of times, most preferably, formed in a labyrinthine shape.

The spray device 2 described in the second embodiment is provided with the liquid leakage prevention unit 84. However, the spray device 2 may not include the liquid leakage prevention unit 84.

### REFERENCE SIGNS LIST

1, 1A, 1B, 1C: Spray device, 2: Spray device, 12: Liquid supply unit, 14: Liquid supply path, 16: Spray unit, 18: Piezoelectric transducer (Ultrasonic transducer), 20: Vibration plate, 20a: Through hole, 21: Spray area, 21a: Upper end of the spray area, 28: Bubble guide path (Branch path), 29: Bubble guide pipe (Branch path), 30: Liquid reservoir, 31: First chamber, 32: Partition wall, 33: Second chamber, 33a: Opening, 34: Liquid passage, 36: Tank (Liquid supply unit), 42: Liquid supply pipe (Liquid supply path), 54: Liquid leakage prevention unit, 56: Housing unit, 58: Liquid supply unit, 60: Chamber unit (Liquid reservoir), 62: Spray unit, 68: Bottom plate (bottom portion), 72: Spacer, 72a: Upper end, 86: Housing unit, 401: Chamber body (Liquid reservoir), 544, 844: Partition plate, 544a, 844a: Notch portion, 582a: Opening end (Liquid supply port), AP: Air path, B: Bubble, L: liquid, S₅₆: Housing space, S₈₆: Housing space

1. A spray device for spraying a liquid, comprising:
a liquid reservoir storing the liquid to be sprayed;
a liquid supply unit supplying the liquid to the liquid reservoir; and
a spray unit in communication with the liquid reservoir, the spray unit comprising an ultrasonic transducer and a vibration plate, the vibration plate having a plurality of through holes, and spraying the liquid in the liquid reservoir by ultrasonic vibration of the ultrasonic transducer,
wherein a liquid supply port of the liquid supply unit is arranged in the liquid reservoir in a state where the liquid supply port faces a bottom portion of the liquid reservoir in the liquid reservoir, and is apart from the bottom portion, and
the liquid reservoir is opened to atmosphere.

2. The spray device according to claim 1, wherein a projection or a spacer is installed upright on the bottom portion, and the liquid supply port is in contact with an upper end of the projection or the spacer.

3. The spray device according to claim 1, wherein the bottom portion has a recess which is continuously formed toward the spray unit from vertically below the liquid supply port.

4. The spray device according to claim 1, wherein a position of an upper end of a spray area of the vibration plate is the same as or below a position of a liquid surface in a liquid reservoir in a vertical direction.

5. A spray device for spraying a liquid, comprising:
a liquid reservoir storing the liquid to be sprayed;
a spray unit arranged vertically below the liquid reservoir, the spray unit comprising an ultrasonic transducer and a vibration plate, the vibration plate having a plurality of through holes, and spraying the liquid in the liquid reservoir by ultrasonic vibration of the ultrasonic transducer;
a liquid supply path supplying the liquid in the liquid reservoir to the spray unit; and
a branch path branching off from a portion of the liquid supply path on the spray unit side, and connected to the liquid reservoir,
wherein the liquid reservoir is opened to atmosphere.

6. The spray device according to claim 5,
wherein the liquid reservoir comprising:
a first chamber into which the liquid is supplied from outside; and
a second chamber arranged on a side of the first chamber, the second chamber being opened to atmosphere,
wherein the liquid supply path is connected to the first chamber, and the branch path is connected to the second chamber.

7. The spray device according to claim 6, wherein the first chamber and the second chamber are adjacent to each other with a partition wall interposed therebetween, and a liquid passage connecting the first chamber and the second chamber is formed at a lower portion of the partition wall in a vertical direction.

8. The spray device according to claim 6, wherein the branch path is connected to a lower portion of the second chamber in a vertical direction.

9. The spray device according to claim 6, further comprising a liquid supply unit supplying the liquid to the first chamber.

10. The spray device according to claim 1, wherein the spray unit sprays upwardly the liquid with respect to a horizontal direction.

11. The spray device according to claim 5, wherein the spray unit sprays the liquid vertically downward.

12. The spray device according to claim 1, wherein an upper portion of the liquid reservoir includes an opening through which the liquid reservoir is opened to atmosphere.

13. The spray device according to claim 12, further comprising a liquid leakage prevention unit provided in the liquid reservoir to block the opening, and preventing liquid leakage of the liquid in the liquid reservoir.

14. The spray device according to claim 13, wherein the leakage preventing portion comprising an air path for allowing atmospheric air to pass into the opening, and the air path is bent at least once.

15. The spray device according to claim 13,
wherein the liquid leakage prevention unit comprises:
a housing unit having a housing space, the housing unit having a first through hole at a position facing the opening, and a second through hole opposite the first through hole in a vertical direction; and
a partition plate partitioning the housing space in a vertical direction,
wherein a region connection path is formed in the partition plate such that the region connection path connects a region above the partition plate and a region below the partition plate at a position deviating from an imaginary straight line connecting the first through hole and the second through hole.

16. The spray device according to claim 15, wherein the liquid leakage prevention unit has a plurality of the partition plates, the plurality of partition plates partition the housing space into a plurality of regions in a vertical direction, adjacent partition plates of the plurality of partition plates are inclined opposite to each other with respect to a vertical direction, and the region connection path formed in each of the adjacent partition plates of the plurality of partition plates is formed at different positions when viewed in a vertical direction.

17. The spray device according to claim 5, wherein an upper portion of the liquid reservoir includes an opening through which the liquid reservoir is opened to atmosphere.

18. The spray device according to claim 17, further comprising a liquid leakage prevention unit, provided in the liquid reservoir to block the opening, and preventing liquid leakage of the liquid in the liquid reservoir,
wherein the leakage preventing portion comprising an air path for allowing atmospheric air to pass into the opening, and the air path is bent at least once.

19. The spray device according to claim 18,
wherein the liquid leakage prevention unit comprises:
a housing unit having a housing space, the housing unit having a first through hole at a position facing the opening, arid a second through hole opposite the first through hole in a vertical direction; and
a partition plate partitioning the housing space in a vertical direction,
wherein a region connection path is formed in the partition plate such that the region connection path connects a region above the partition plate and a region below the partition plate at a position deviating from an imaginary straight line connecting the first through hole and the second through hole.

20. The spray device according to claim 19, wherein the liquid leakage prevention unit has a plurality of the partition plates, the plurality of partition plates partition the housing space into a plurality of regions in a vertical direction, adjacent partition plates of the plurality of partition plates are inclined opposite to each other with respect to a vertical direction, and the region connection path formed in each of the adjacent partition plates of the plurality of partition plates is formed at different positions when viewed in a vertical direction.
